(19) United States
(12) Patent Application Publication
(10) Pub. No.: US 2014/0085693 A1
(43) Pub. Date: Mar. 27, 2014

(54) METASURFACE NANOANTENNAS FOR LIGHT PROCESSING

(71) Applicant: Northeastern University, Boston, MA (US)

(72) Inventors: Hossein Mosallaei, Lexington, MA (US); Mohsen Farmahini Farahani, Malden, MA (US); Babak Memarzadeh Isfahani, Needham, MA (US)

(73) Assignee: Northeastern University, Boston, MA (US)

(21) Appl. No.: 14/038,522

(22) Filed: Sep. 26, 2013

Related U.S. Application Data
(60) Provisional application No. 61/754,114, filed on Jan. 18, 2013.
(60) Provisional application No. 61/705,822, filed on Sep. 26, 2012.

(51) Int. Cl. G02F 1/01; G06E 3/00; G02B 5/30

(52) U.S. Cl. CPC G02F 1/01; G02B 5/3083; G06E 3/00
USPC 359/107; 359/360; 359/485.01; 359/238

(57) ABSTRACT

A birefringent reflectarray having a planar metasurface containing metallic patches of subwavelength dimension is provided. The reflectarray is capable of simultaneously reflecting, concentrating, and splitting incident infrared light into two orthogonal linearly polarized reflections, and transforms the phase front of an incoming polarized light to a desired phase for the two reflections. Also provided is an optical modulator having a metasurface containing layers of nanoantennas of subwavelength dimension, and capable of modulating the phase and amplitude of light scattered from the modulator. The optical modulator has ability to perform computation through processing of light.

### CROSS REFERENCE TO RELATED APPLICATIONS

This application claims the benefit of provisional application Ser. No. 61/705,822, filed Sep. 26, 2012 and entitled “METASURFACES WITH NANOANTENNA INCLUSIONS: a NEW WAY OF LIGHT PROCESSING”, and provisional application Ser. No. 61/754,114, filed Jan. 18, 2013 and entitled “METASURFACE NANOANTENNAS FOR LIGHT COMPUTATION” which are hereby incorporated herein by reference in their entireties.

### STATEMENT REGARDING FEDERALLY SPONSORED RESEARCH OR DEVELOPMENT

The invention was developed with financial support from U.S. Office of Naval Research Grants No. N00014-10-1-0264, and N00014-10-1-0942. The U.S. Government has certain rights in the invention.

### BACKGROUND

In recent years several developments have taken place for controlling of manipulating light at subwavelength scale by metasurfaces. Planar patterns of nanoantennas (metallic patches, dipoles, loops, slits, nanoholes, and core-shells) have been used to control the phase, amplitude, and polarization of an incident wave both in reflection and transmission modes [(Lezec et al., 2002; Huang et al., 2007; Verslegers et al., 2009; Ahmadi et al., 2010; Lin et al., 2010; Shelton et al., 2010; Khoo et al., 2011; Yu at al., 2011; Zhao et al., 2011; Roberts et al., 2012; Carrasco et al., 2013). However, metasurfaces capable of tailoring the transmission amplitude and phase profiles independent of each other have not yet been described.

With regard to reflection, minors have been used as simple light reflectors in optical systems. The function of mirrors is based on Snell's law of reflectionre, viz., reflection angle is equal to the incidence angle). Optical reflectarrays, or planar quasi-periodic arrays of subwavelength nanoantennas, make it possible to locally manipulate the phase of the incoming wave on the surface of the array to produce additional types of reflections. The geometry of each individual nanoantenna can be precisely engineered, thanks to nanoscale fabrication techniques, to provide the desired reflected beam.

Previously, several reflectarrays in the infrared and optical range (Ginn et al., 2006; Ginn et al., 2007; Ginn et al., 208; Ahmadi et al., 2008; Gómez-Pedrero et al., 2011; Shelton et al., 2010), have been demonstrated. The most commonly used nanoantennas in reflectarrays are rectangular metallic patches. In these patches the length of each patch determines the phase to which the phase of the incoming wave is transformed, assuming that the length of the patch is parallel to the polarization of the incoming wave. The same transformation (reflection angle) is obtained for a beam of wave polarized along the width of the patch if square patches are used instead. However, a birefrigent metasurface reflectarray has not been described.

### SUMMARY

An embodiment of the invention is a birefringent infrared reflectarray including a planar metasurface disposed on a surface of a substrate, the metasurface including a metal layer, a dielectric layer deposited on the metal layer, and a nanoantenna layer deposited on the dielectric layer; such that the nanoantenna layer includes a plurality of rectangular metal patches arranged in a two-dimensional rectilinear array, each row of the array including a series of said metal patches whose length and/or width increases from one to the next across the row; such that the patches reflect incident infrared light of wavelength λ and split the incident light into two orthogonal linearly polarized reflections, concentrate the reflected light, and transform the phase front of the incoming polarized light to a desired phase for the two reflections; and such that the dimensions of the metallic patches are less than λ. For example, the wavelength of the incident light is in the range of about 3 μm to about 30 μm, and the dimensions of the metallic patches are in the range of about 300 nm to about 3 μm.

In related embodiments of the invention the dielectric layer includes a material selected from the group consisting of: metal oxides, plastics, mica, ceramic materials, SiO₂, and glass. In other related embodiments, the metal layer and the metal patches each comprise gold.

Related embodiments of the invention include a reflectarray such that the thickness of the metal patches is in the range of about 25 nm to about 100 nm.

According to other related embodiments of the invention, the reflectarray is configured as a waveplate, a birefringent modulator, or a polarization diversity wavelength multiplexer/de-multiplexer.

Another embodiment of the invention is a birefringent visible light reflectarray including a planar metasurface disposed on a surface of a substrate, the metasurface including a nanoantenna layer including a plurality of ellipsoid particles having a dielectric core and a shell of plasmonic material and arranged into a two-dimensional rectilinear array, each row of the array including a series of said particles having a different length along at least one of three axes of the particles from one to the next across the row; such that the particles reflect incident linearly polarized visible light of wavelength λ and split the incident light into two circularly polarized reflections and transform the phase front of the incident light to a desired phase for the two reflections; and such that the dimensions of the particles are less than λ.

In another embodiment the invention is an optical modulator for independently modulating the phase and amplitude of light scattered from the modulator, the modulator including a metasurface disposed on a surface of a substrate, the metasurface including a first nanoantenna layer disposed on said surface of the substrate and a second nanoantenna layer disposed on the first nanoantenna layer; such that the first nanoantenna layer includes a plurality of first nanostructures and the second nanoantenna layer includes a plurality of second nanostructures, such that each first nanostructure is disposed directly below a second nanostructure to form a unit cell, such that the unit cells are arranged in a two-dimensional rectilinear array; such that the first nanostructures are L-shaped slot structures in a metal film, the slot structure having arms of lengths h₁ and h₂, such that h₁ and h₂ are varied from one slot structure to the next across each row of the array while keeping the sum of h₁ and h₂ constant, whereby variation of h₁ and h₂ modulates a transmission amplitude of the scattered light independent of the transmission phase, such that wherein the second nanostructures are concentric metal loop structures, whereby variation of the sizes of the loop structures from one to the next across the each row of the array modulates the transmission phase of the scattered light independent of the amplitude. For example, the sizes of the loops either increases or decreases going from the center of the loop structure to the periphery of the loop structure.

A related embodiment of the invention is a computing device for performing multiplication including the modulator of the embodiment above, such that the values of h₁ and h₂ are selected in a manner that the scattered E_{y} amplitude is in the range of about 0.25 to about 10.0 at the resonance frequency of the L-shaped slot.

In related embodiments the invention is a computing device for performing differentiation including the modulator of the embodiment above, the device further including a Fourier transform (FT) block material disposed on one side of said substrate and an inverse Fourier transform (IFT) block material disposed on the other side of said substrate; such that each of the FT and the IFT blocks includes a GRIN flat lens; and such that an incident beam enters the FT block and is transmitted through the IFT block, whereby the transmitted beam is the first differential with respect to time of the incident beam.

Another embodiment of the invention is a method of performing a computation using light, including the steps of: (a) directing a light beam at the modulator of claim 10, whereby light is scattered from the metasurface; and (b) measuring a property of the scattered light.

In related embodiments of the invention, the second nanostructures of the modulator includes concentric multimaterial loop structures having a plurality of loops, each loop made from a different plasmonic material, the loops separated by dielectric material, whereby variation of the loop structures across each row of the array changes the transmission phase of the scattered light independent of the amplitude.

A further embodiment of the invention is an optical transmitarray capable of focusing and/or bending transmitted light, the transmitarray including a planar metasurface disposed on a surface of a substrate, the metasurface including a nanoantenna layer deposited on a dielectric layer; such that the nanoantenna layer includes a plurality of metal nanostructures arranged in a two-dimensional rectilinear array, each row of the array including a series of said nanostructures whose shape and/or dimension change from one to the next across the row; such that the nanostructures transmit incident light of wavelength λ and modulate its phase; and such that dimensions of the nanostructures are less than λ.

In related embodiments of the invention the nanostructures of the transmitarray are flat metal structures having a geometry selected from the group consisting of rectangular loops, concentric rectangular loops, squares, and rectangles.

In other related embodiments of the invention the nanostructures of the transmitarray vary along each row in the number of concentric loops, gap size between concentric loops, loop size, loop thickness, loop material, and/or use of closed vs. open nanostructures. According to other related embodiments of the invention, the nanostructures are core-shell nanoparticles that vary in diameter, aspect ratio, core diameter, shell thickness, core material, and/or shell material.

Related embodiments of the invention include a transmitarray including a second dielectric layer disposed on the nanoantenna layer and a second nanoantenna layer disposed on the second dielectric layer. In other related embodiments, the transmitarray includes a third dielectric layer disposed on the second nanoantenna layer and a third nanoantenna layer disposed on the third dielectric layer. According to other related embodiments, the nanostructures of the transmitarray are asymmetric with respect to their x and y axes, such that the transmitarray is capable of converting a linearly polarized incident light beam into a circularly polarized transmitted light beam.

Another embodiment of the invention is a device for altering the amplitude, phase, polarization, and/or direction of incident light, the device comprising a metasurface deposited on a surface of a substrate, the metasurface including one or more nanoantenna layers, each nanoantenna layer including a two-dimensional rectilinear array of nanostructures including a plasmonic material and having dimensions less than the wavelength of the incident light, and the nanoantenna layers separated by dielectric layers; such that the nanostructure geometry, size, aspect ratio, and/or composition are varied across each row of the array according to a graded pattern. In related embodiments of the invention, the device further includes a reflective metal layer between a nanoarray layer and the substrate, such that the device is configured as a reflectarray. In other related embodiments the device is devoid of reflective or opaque material beneath the nanoantenna layer or layers, such that the device is configured as a transmitarray.

In the above embodiments of the invention, a substrate is a material such as silicon, silicon dioxide, glass, a polymer, a metal, a part of a circuit, etc. Further, the substrate is translucent, transparent, opaque, or reflective, depending on the device and its function, and the dimensions of the substrate may have any value according to the application, such as, for example, a thickness from 100 nm to 1 mm or more, and can be planar, nonplanar, or shaped, as required by the application.

### BRIEF DESCRIPTION OF THE DRAWINGS

FIG. 1. is a diagram of a unit cell of a birefringent metasurface reflectarray having gold metalpatch (101) nanoantennas on top of a substrate (102) grounded silicon stand-off layer. a=1.2 μm, h=300 nm, and t=50 nm. The grounding is provided by the metal layer (103) on the opposite side of the metal patch.

FIG. 2. is a S-diagram of the unit cell shown in FIG. 1 showing variation of phase delay as a function of patch length (dₓ). Each curves has a different (d_{y}). Larger values of (d_{y}) leads to smoother curves, and improved phase resolution with respect to (dₓ).

FIG. 3. is an array of 16λ×16λ reflectarray metasurface (301). The enlarged part shows individual metallic patches (302) and (dₓ) variations. The value of (dₓ) is changes from 400 to 1100 nm in 100 nm steps.

FIG. 4A is a two-dimensional representation of normalized intensity of the reflected beam in θ₀ₓ=45° and φ₀ₓ=0°.

FIG. 4B is a graph of normalized |E²| as a function of θ at φ=0, x-z, cut. The half-power beam width (HPBW) is 8°.

FIG. 5A is part of the birefringent nanoantenna metasurface. and d_{y} are discretized with steps of 50 nm.

FIG. 5B is graph showing variation in patch length dₓ as a function of x for one period.

FIG. 5C is graph showing variation in patch width d_{y} as a function of x for one period.

FIG. 5D is a graph showing theoretical (solid line) and realized (rectangles) ψₓ(x, y) for one period.

FIG. 5E is a graph showing theoretical (solid line) and realized (rectangles) ψ_{y}(x, y) for one period. At x=0, the phase delays cannot be realized with any of the available patches.

FIGS. 6A and 6B are two-dimensional representations of normalized intensity of the reflected beam for x- and y-polarized illuminations respectively. The beam is reflected in θ₀ₓ=30° and φ₀ₓ=0° direction for the x-polarized illumination, and θ_{0y}=−30° and φ_{0y}=0° direction for the y-polarized illumination.

FIG. 6C is a graph of normalized |E²| as a function of θ at φ=0, x-z, cut of both reflected beams.

FIG. 7 is a block diagram of a system with a metasurface, an FT and an IFT block.

FIG. 8A is a diagram of a L-shaped slot in a thin metal film. The total slot length is h=h₁+h₂.

FIG. 8B is a diagram of a symmetric L-shaped slot (h₁=h₂) that transmits only Eₓ when illuminated by Eₓ.

FIG. 8C is a diagram of an asymmetric L-shaped slot (h₁≠h₂) that scatters a y-directed component in addition to a x-directed component. Superscripts in and t stand for incident and transmitted, respectively, and subscript ind stands for induced. Solid and dashed arrows show electric filed and magnetic current, respectively.

FIG. 9A is a graph showing the relationship between scattered E_{y} amplitude (y-axis) and Δh=|h₁−h₂|. The resonance of the L-shaped slot is at 60 THz (x-axis). The scattered E_{y} amplitude changes considerably as Δh is changed.

FIG. 9B is a graph obtained by plotting values of scattered E_{y} phase against resonance of the L-shaped slot. Since the total length of the L-shaped slot h=h₁+h₂ is fixed (1 μm), the phase variation obtained as Δh changes is very small at resonant frequency. [The graph at right shows phase variation in detail.

FIG. 10A is a schematic diagram of an array (1004) having unit cells containing concentric metal loops. The enlarged portion at the top left shows a section with outer metal loop (1002), and inner metal loop (1003) on a substrate (1001).

FIG. 10B is a diagram of a unit cell of concentric metal loops. The background refractive index is 3.15, wₒ=100 nm and wᵢ=50 nm.

FIG. 10C is a graph showing variation of transmission amplitude with variation in Lᵢ and Lₒ. The variation in amplitude is very small.

FIG. 10D is a graph showing variation of phase variation with variation in Lᵢ and Lₒ at λ=5 μm. The variation in phase is considerable.

FIG. 11A is a diagram of a double-layered unit cell composed of the unit cells in FIGS. 8A and 10B.

FIG. 11B is a graph of transmission amplitude (y-axis) against |h₁−h₂| for different values of the loop parameter Lᵢ. The loop parameter Lₒ is 550 nm. Amplitude changes strongly as |h₁−h₂| varies.

FIG. 11C is a graph of transmission phase (y-axis) against |h₁−h₂|. The different curves correspond to the different values of the loop parameter Lᵢ shown in FIG. 11B. The loop parameter Lₒ is 550 nm. Phase remains virtually unchanged as |h₁−h₂| varies.

FIG. 11D is a graph of transmission amplitude (y-axis) against the loop parameter Lₒ (x-axis). The curves correspond to different values of the loop parameter Lᵢ as shown in FIG. 11B. The amplitude remains almost constant when concentric loops parameters are swept.

FIG. 11E is a graph of transmission phase (y-axis) against the loop parameter Lₒ. The curves correspond to different values of the loop parameter Lᵢ as shown in FIG. 11B. The phase undergoes considerable variation as the concentric loops parameters are swept.

FIG. 12A is a schematic diagram of metasurface of L-shaped slots designed to multiply the incident wave by Tₛ( y̅)∝ y̅. Shown are the metasurface (1203) embedded between two dielectric layers (1201, 1202), and a side view of the nanoantenna layer containing L-shaped slots on a thin metal (1204).

FIG. 12B is a graph of transmission amplitude (vertical-axis) as a function of distance (horizontal-axis) along the direction of change in h₁ (and h₂; see FIG. 12A). The uniform amplitude of a rectangular pulse is reformed into linear amplitude after passing through the metasurface. In the horizontal axis 0 represents the position where h₁=h₂

FIG. 12C is a graph of phase as a function of distance (x-axis) along the direction of change in h₁ (and h₂; see FIG. 12A). Phase is shifted 180° for negative values of y̅. (Solid lines represent simulation results and dashed lines are ideal output profile.)

FIG. 13 is a schematic of Fourier transformation (FT) by GRIN material. The GRIN material with the profile defined in Equation (4) yields accurate FT as long as refractive index variations are small. For best performance the spatial extent of the beam is concentrated in the center of the GRIN material. The refractive index variation is shown by the curve at the right.

FIG. 14A is a diagram of a spatial differentiator consisting of an FT block (1401), a block of metasurface (1402), and an IFT block (1403) cascaded to perform differentiation.

FIG. 14B is a set of graphs showing profile monitors at each block. A Sinc function is sourced into the spatial differentiator and its derivation is obtained on the other side.

FIG. 15A is a diagram of a cascaded metasurface array for controlling both amplitude and phase of the transmitted beam independent of each other. This metasurface reshapes the rectangular pulse profile of the input beam to a triangular pulse. The transmission phase is reformed to an inverse triangle shape at the same time. The top layer (1501) with the L-shaped slots (1503), controls the amplitude and the bottom layer (1502) with loops (1504), tailors the phase.

FIG. 15B is a graph of output amplitude as a function of distance (y-axis) along the direction of change in h₁ (and h₂; see FIG. 12A).

FIG. 15C is a graph of output phase as a function of distance (y-axis) along the direction of change in h₁ (and h₂; see FIG. 12A). In FIGS. 15B and 15C, the squared lines are the designed values obtained from the simulation of the separate unit cells. Data obtained FIGS. 9 and 10. The red solid line is from full wave FDTD with Lumerical solver and the thick black line is the input beam amplitude.

FIG. 16A is a schematic diagram of the multimaterial loops metasurface. The first (1601), third (1602) and fifth (1603) loops from the periphery represent the plasmonic loops, while the second (1605) and the fourth loop (1604) represent the dielectric loops.

FIG. 16B is a diagram of the parameters of the loop geometry.

FIG. 16C is a graph of transmission and reflection coefficients for a single plasmonic loop metasurface. In the inset the charge distribution on the surface of the loop is shown for the excited dipole mode.

FIG. 17A is a graph showing resonant permittivity of a single plasmonic loop metasurface the height of 0.145λp.

FIG. 17B is a graph showing resonant permittivity of a single plasmonic loop metasurface the height of 0.2175λp. For FIGS. 16A and B, the horizontal axis is the aspect ratio of the loop, and the vertical axis is the loop radius normalized to the plasma wavelength of the plasmonic material. The bars on the right show resonance permittivity.

FIG. 18 is a graph showing resonant frequency obtained by Equation (4) and the data in FIG. 17A for materials of silver (FIG. 18A), gold ((FIG. 18B), ITO (FIG. 18C), and AZO (FIG. 18D). In each figure the geometry of the loop has been scaled up to the plasma wavelength of the material, including the radius, height, and center to center distance on the array. The bars on the right show the resonant frequency in terahertz unit.

FIG. 19 is a set of graphs showing transmission coefficients of four different multimaterial loop metasurface designs with low coupling between the concentric loops.

FIG. 19A is a graph of a plot of transmission coefficients against frequency of a multimaterial loop metasurface design in which both loops are made of silver with radii of 125 and 75 nm for the outer and inner loop, respectively. The thickness of each loop is considered to be 10 nm.

FIG. 19B is a graph of a plot of transmission coefficients against frequency of a multimaterial loop metasurface design in which the outer loop with radius of 100 nm and thickness of 10 nm is considered silver while the inner loop with radius of 60 nm and thickness of 12.5 nm is assumed to be gold.

FIG. 19C is a graph of a plot of transmission coefficients against frequency of a multimaterial loop metasurface made out of ITO for the outer loop with radius of 624 nm and thickness of 312 nm, and of AZO for the inner loop with radius of 208 nm and thickness of 156 nm.

FIG. 19D is a graph of a plot of transmission coefficients against frequency of multimaterial loop metasurface with three concentric silver loops. The radii are 125, 85, and 40 nm and all the loops have the same thickness of 10 nm. The various dotted lines correspond to transmission coefficients for the array of the loops as shown. For the designs containing silver or gold the height of the loops are considered to be 20 nm and the center to center distance between the multimaterial loops is considered to be 300 nm. For the designs with TTO or AZO the height is assumed to be 104 nm and the center-to-center distance is 1.56 μm.

FIG. 20 is a set of two diagrams showing charge distribution on the surface of the multimaterial loop design corresponding to FIG. 19A at two resonances: first resonance (FIG. 20A), and second resonance (FIG. 20B).

FIG. 21A-D is a set of diagrams showing electric field intensity distribution for multimaterial loop metasurface of the design shown in FIG. 19A.

FIG. 21A shows electric field intensity distribution for the multimaterial loop metasurface at the first resonance.

FIG. 21B shows electric field intensity distribution for single outer loop metasurface at its resonance.

FIG. 21C shows electric field intensity distribution for the multimaterial loop metasurface at the second resonance.

FIG. 21D shows electric field intensity distribution for single inner loop metasurface at its resonance. The dashed lines show the boundary of the plasmonic loops. The bars on the right show the electric field intensity in (V/m)².

FIG. 22A-D is a set of diagrams showing the performance of multimaterial loop metasurface with high coupling between the loops.

FIG. 22A is a graph of the transmission coefficient of the multimaterial loop (solid line), the outer loop (dashed line), and the inner loop (dashed-dotted line).

FIGS. 22B-D show the charge distribution of frequencies (I), (II), and (III), respectively. At each of these figures the left arrows show the dipole moment of inner loop, the right arrows show the dipole moment of the outer loop, and the center arrows show the net dipole moment of the multimaterial loop building block.

FIG. 23A-C is a set of diagrams showing electric field intensity distribution at three frequencies labeled by (I) to (III) in FIG. 22 in (V/m)². FIG. 23D-F show the same, respectively, in the dB unit. The figures in dB unit are normalized to the maximum value of the field intensity in FIGS. 23A-C.

FIG. 24A-F is a set of graphs showing the effect of spacer layer permittivity and loss on the resonances of the multimaterial metasurface.

FIG. 24A shows the transmission coefficient of the low-coupled multimaterial loop metasurface design.

FIG. 24B shows first and second resonant frequencies versus the spacer layer permittivity.

FIG. 24C shows the transmission coefficient of the high-coupled multimaterial loop metasurface design.

FIG. 24D shows the change in the frequencies of the two nulls in the transmission coefficient versus the spacer layer permittivity. The dashed lines in FIGS. 24B and 24D are the line fitted on the data.

FIG. 24E and FIG. 24F show the absorption of the metasurface for low-coupled and (f) high coupled designs, respectively. In the two later figures the permittivity of the spacer layer is assumed to be ∈ᵣ=2+j0.02 for the solid curve and ∈ᵣ=2+j0.2 for the dashed curve.

FIG. 25 is a schematic diagram of an exemplary transmitarray capable of changing the direction of incident light, and of converting a linearly polarized light to a circularly polarized light. The transmitarray has an array of metallic patches of different subwavelength dimensions surrounded by a substrate.

### DETAILED DESCRIPTION

The invention provides new materials, which are metasurfaces containing nanoantennas, that process light by changing its amplitude, phase, polarization, direction, and/or concentration. The metasurfaces according to the invention are thin, flexible, lightweight, and flat, yet they can replace traditional bulky lenses and other optical materials with equivalent or better performance. The metasurfaces of the invention can be integrated into optical systems and used on-chip to provide optical circuitry and processing, including functional logic gates and optical computation (i.e., photonic computing).

The metasurfaces of the invention are characterized in having a “smart” graded pattern of nanoantennas. The nanoantennas are inclusions, typically nanostructures, of plasmonic material, such as a metal, embedded in or deposited on or embedded into the surface of a dielectric material. The dielectric material otherwise preferably lacks inclusions, particularly plasmonic element inclusions. The nanoantennas have all dimensions of extent (e.g., diameter, length, width, height, diagonal, etc.) smaller than the wavelength of light they are intended to process, and they can have a variety of different geometries. The geometry of the individual nanoantenna elements can be, for example, rectangular, square, circular, elliptical, spherical, ellipsoidal, layered particle (e.g., core-shell nanoparticle, including core-shell sphere and core-shell cylinder), ring or loop (rectangular, square, circular, or elliptical), torus, toroid, concentric loops, an L-shaped or V-shaped slot in a plasmonic material, or other geometric shapes. Preferably, the shape of the nanoantenna elements is selected to alter the light phase, polarization, and/or amplitude. Nanoantenna elements are arranged in an array within a nanoantenna layer of the metasurface. The array can be, for example, a two-dimensional rectilinear array pattern, or another array pattern, including 3-dimensional array patterns. Preferably, the shape of the nanoantenna elements is modified according to a graded pattern along each row of a rectilinear array, and the modifications are selected according to known relationships that allow the phase, polarization, and/or amplitude of light to be processed and/or modulated in two- or three-dimensions.

The metasurfaces of the invention can be integrated into various devices including, for example, reflectarrays, transmitarrays, and optical modulators. Such devices can control incident light in many ways, such as to concentrate it into one or more beams projected in a desired direction, bent, reflected, or having altered polarization, amplitude, or phase. A reflectarray contains a reflective layer (e.g., a metal layer) beneath the one or more nanoantenna layers and between the nanoantenna layers and the substrate on which the metasurface is situated. The incident beam is thus modified and reflected back in the direction of the incident beam. A transmitarray lacks the reflective layer, and forms an altered, processed light beam that is transmitted through the metasurface and the substrate on which it is situated. An optical modulator functions similar to a transmitarray, but performs a specifically designed modulation or processing of the incident light beam, e.g., performing a logical or mathematical operation such as addition or differentiation and outputting the result as a transmitted or scattered light output.

An embodiment of the invention described below is a birefringent metasurface reflectarray. A birefringent reflective metasurface is defined as a surface with double reflections. The metasurface reflects and simultaneously splits an incoming unpolarized light into two orthogonal, linearly polarized reflections. The metasurface described here are useful as component of conventional optical devices, such as modulators, waveplates, color filters, and splitters, that use birefringence effects. The metasurface described here is also useful in systems that manipulate polarization of light, such as multiplexers/demultiplexers. (Glance et al., 1987)

To understand the design of the birefringent metasurface reflectarray, a reflectarray was considered that functions for only one polarization. A reflectarray including metallic-patch unit cells placed in the x-y plane was considered for achieving reflection of an x-polarized incoming beam into a specific direction of θ₀ₓ and φ₀ₓ. The reflection phase-delay distribution on the surface of the reflectarray is described by

ψₓ(x,y)=k₀ sin θ₀ₓ[x cos(φ₀ₓ)+y sin(φ₀ₓ)] (1)

where k₀ is the free-space wavenumber.

The illuminating beam of light was considered to be Gaussian beam. Therefore, each nano scale patch unit cell located at (x, y) could be taken as delaying the incoming phase by ψₓ(x, y). Next, patch unit cell dimensions were determined to provide the desired phase delays.

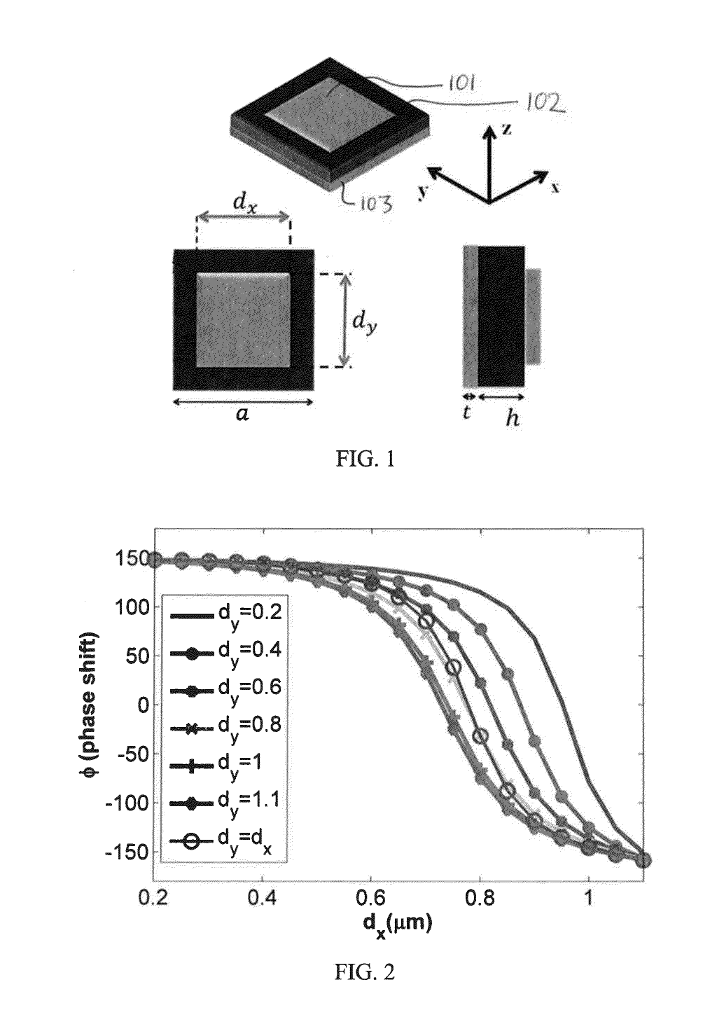

FIG. 1 shows a patch unit cell, the building block of the reflectarray. The wavelength (λ) of the incoming beam of light was selected to be 8.06 μm. The patch and the ground metals are gold, and the stand-off layer dielectric is silicon of 300 nm thickness. The unit cell size was 1.2 μm, which is slightly larger than the patch resonance length, and the gold layer thickness was 50 nm.

Lumerical, a finite-difference time-domain solver from Lumerical, Inc., (Vancouver, Canada) was used to calculate the reflection phase of the patch unit cell. The illuminating wave was x-polarized and a periodic boundary condition was applied. FIG. 2 shows the curve of phase delay versus patch length (dₓ). Patch width (d_{y}) was also swept as a parameter. These curves are called S-diagrams (Pozar et al. 1999). As depicted, a phase delay range of 300° was obtained by sweeping dₓ. For larger values of d_{y}, the slope of the S-diagram was smoother, and it was possible to get a lower phase delay sensitivity versus c. Also, the reflection remains closer to unity when d_{y} is larger, implying higher reflection efficiency.

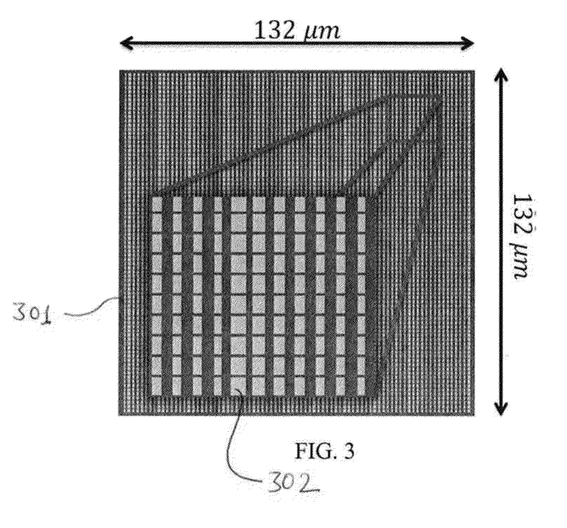

Using Equation (1), for instance for θ₀ₓ=45° and φ₀ₓ=0°, the reflection phase at each (x, y) location was obtained and the associated patch size determined from the S-diagram. FIG. 3 depicts the designed 16λ×16λ metasurface. The reflectarray pattern is uniform along the y direction because φ₀ₓ=0° was selected. Also, only the curve corresponding to d_{y}=1.1 μm (FIG. 2) was used for the design.

The structure was simulated with Lumerical. For simulation and fabrication purposes, the values of d_{y} were discretized in 100 nm steps. This caused a maximum phase-delay discretization error of 16°. This error did not change the reflection direction and only slightly widened the beam. The metasurface was illuminated with a normal Gaussian beam with a 40 μm beam waist.

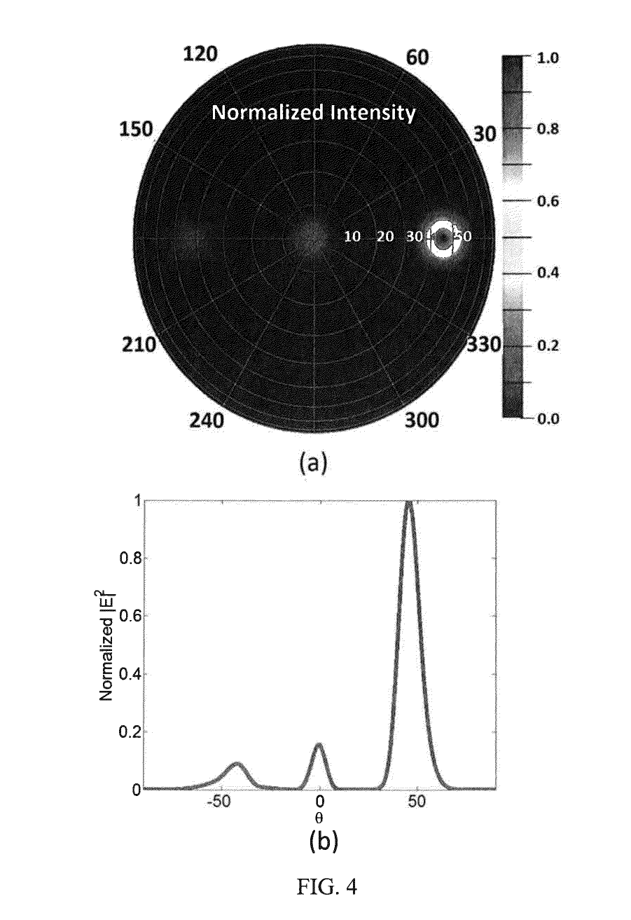

FIG. 4A shows the normalized intensity of the reflected beam. The field was reflected back into θ₀ₓ=45° and φ₀ₓ=0 as determined. The φ=0 cut is shown in FIG. 4B. The half-power beam width (HPBW) was 8°. Thus, the designed metasurface scans the beam in a desired direction, and, further, it concentrates the light with a narrow divergence angle.

The method was similarly applied to an incoming y-polarized beam. A phase-delay distribution was applied to a y-polarized beam on each patch to reflect the beam into the direction defined by θ_{0y} and φ_{0y}:

ψ_{y}(x,y)=k₀ sin θ_{0y}[x cos(φ_{0y})+y sin(φ_{0y})] (2)

For obtaining a birefringent metasurface, both phase distributions for x and y polarizations should be satisfied at the same time. In other words, a proper patch size has to be found at each (x,y) that reflects Eₓ(x, y) with ψₓ(x,y) and Eᵥ(x, y) with ψᵥ(x, y).

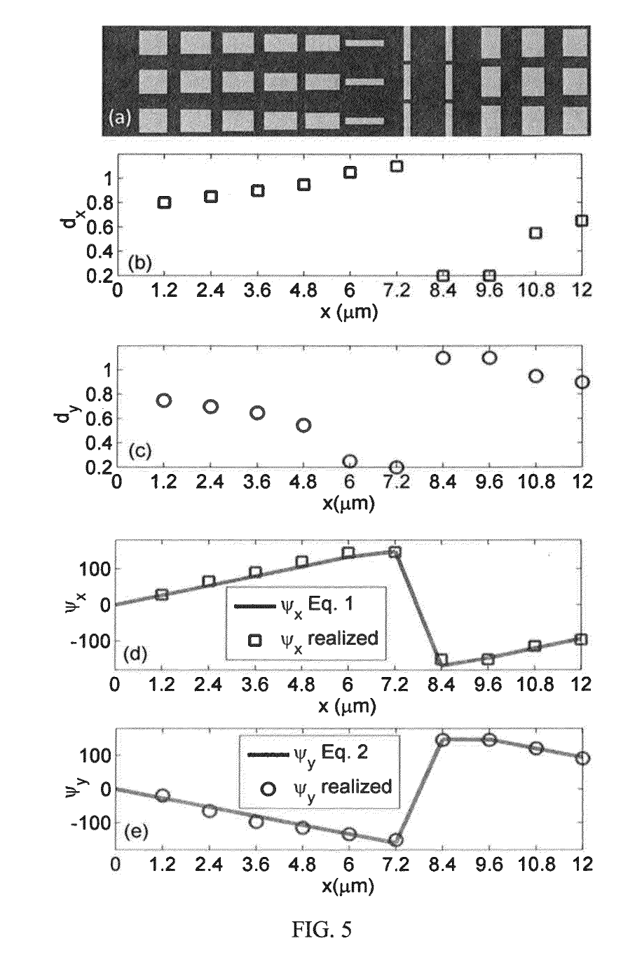

The S-diagram in FIG. 2 can be used for ψᵥ(x,y) by interchanging dx and dy. Therefore, the data related to patch dimension (dx, dy) and the associated calculated phase delay (ψₓ, ψᵥ) may be searched for patch size pairs (dx, dy), that simultaneously satisfy ψₓ(x, y) and ψ_{y}(x, y) at each position. A search algorithm with a reasonable phase tolerance (20°) was devised to obtain those (dx, dy) pairs. The x-directed field was reflected in θ₀ₓ=30° and φ₀ₓ=0° and the y-directed electric field into θ_{0y}=−30° and φ_{0y}=0°. A part of the resulting reflectarray is shown in FIG. 5. The parameters, dₓ, d_{y}, ψₓ(x, y), and ψᵥ(x,y) are depicted as a function of x for one period. In FIGS. 5D and 5E, the solid curves show the reflection phase calculated from Equations (1) and (2), and the square and circle marks show the realized reflection phase for x and y polarizations, respectively. The realized phase delays were close to the designed values, implying that the mathematical approach is successful.

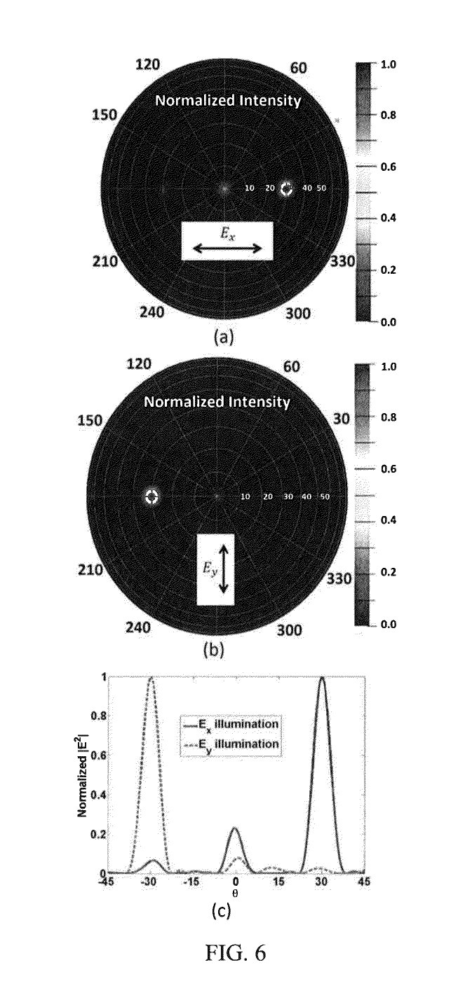

FIGS. 6A and 6B show the reflected beam when the reflectarray is illuminated with x- and y polarized waves, respectively. The beam is reflected in θ₀ₓ=30° when an x-polarized field illuminates the array, while it is reflected in θ₀ᵥ=−30° when illuminated by a y-polarized beam. FIG. 6C depicts the x-z cut of both reflected beams. Therefore, any incoming light with polarization other than x or y undergoes a double reflection, realizing a birefringent metasurface.

Further, the metasurface reflection efficiency obtained by averaging the reflections from each patch was calculated to be 92%. The high reflection efficiency provides a significant opportunity for light engineering in the IR spectrum.

Another embodiment of the invention is subwavelength scale multimaterial loops as components of a functional metasurface. The suitability of the multimaterial loops as components of a functional metasurface is based on the optical properties of localized surface plasmon wave of the materials forming the multimaterial loops. The optical properties of localized surface plasmon wave are suitable for a and wide variety of applications (Zhang et al., 2008; Chen et al., 2010; Ferry et al., 2010; Memarzadeh et al., 2011; Zhao et al., 2011; Chettiar et al., 2012; Wu et al., 2011). The plasmon wave is localized on the surface of subwavelength plasmonic particles at a specific frequency that is dictated by the particle geometry and the optical properties of the material (Ahmadi et al., 2011). Subwavelength inclusions with different shapes are employed in order to fulfill the desired performance in different applications such as optical sensing, cloaking, high-resolution imaging, optical filtering, etc. (Memarzadeh et al., 2011; Zhao et al., 2011; Wu et al., 2011; Xu et al., 2010; Memarzadeh et al., 2012; Yu et al., 2011). The dependency of this resonance phenomenon on the subwavelength particle's shape, and the high intensity of the resonance near field opens the possibility for bringing different subwavelength particles close to each other to provide novel physics &Wu et al., 2011; Hao et al., 2009; Fan et al., 2010; Nano Lett.; Fan et al., 2010 Science). Also, advances in nanofabrication have made it more realistic to design more complex structures to achieve a desired performance. Nanoskiving has shown to be a capable method of fabricating concentric loops with different materials in a large-size array (Lipomi et al., 2010).

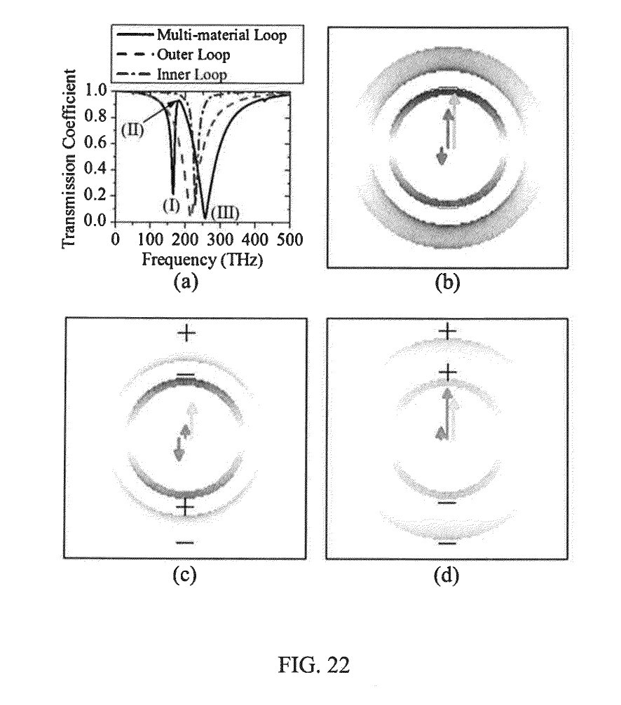

Described herein is the performance of a single plasmonic loop array for designing multimaterial loop metasurfaces with low and high coupling between the concentric loop nanoantennas. For the low-coupled multimaterial loop metasurface the parameters of the loops were chosen such that their resonant frequencies are far apart from each other. Four different designs are described herein. In the first design the two loops are considered silver. In the second design, by considering gold as the inner loop the effect of a higher plasma damping factor is shown. In the third design, by changing the material of the loops from silver and gold to ITO and AZO with lower plasma frequency the ability to bring the resonant frequency down from short infrared to long infrared is demonstrated. The dimensions in each design are directly related to the plasma frequency of the materials used in the building block. The fourth design shows yet another capability of this building block in which three resonances that are not coupled to each other are controlled by the aspect ratio of the three concentric loops in the building block. Although, in this case the coupling between the loops is small, the subradiant and superradiant characters of each resonance are revealed by the induced dipole moments on each loop. High coupling is achieved by bringing the resonance of the loops close together. Unique resonance characteristics, including a Fano-like feature, are demonstrated. (FIG. 22). Taking advantage of the hybridization model the characteristics of different resonances are evaluated based on the induced net dipole moments. The appearance of the dark mode is illustrated by showing the equal but antiparallel dipole moments of the inner and outer loops. The sensitivity of the performance of both designs to the spacer layer permittivity and loss is studied as well. It is shown that for the high-coupled design there are two resonances with completely different characteristics. One is narrow in bandwidth with large field enhancement and extremely sensitive to the spacer layer material. The other resonance phenomenon has a wide bandwidth with low loss. The building block at both frequencies is subwavelength (λ/7 and λ/5, respectively). The first resonance can be integrated for near field applications such as sensing and nonlinear optics, while the second resonance can be used for making wideband low-loss metamaterials. The multimaterial loop building block provides great opportunity in design space when one can tailor very unique optical features by controlling the aspect ratio of each loop and their couplings.

The theory which forms the basis of the subwavelength scale multimaterial loops is described in the following. Based on the Mie theory, a subwavelength plasmonic sphere goes to resonance when its permittivity is around −2 (Bohren et al., 1998). Changing the aspect ratio of the particle can control the permittivity value at which the structure will provide resonance (Ahmadi et al., 2011). In other words, for any subwavelength plasmonic particle, based on its shape there will be a specific permittivity that makes the inclusion resonate regardless of the plasmonic material (resonant permittivity). For an array of single plasmonic loops the radius, height, and thickness of the loops play critical roles in defining the resonant permittivity (Aizpura et al., 2003). Due to the field enhancement on the surface of the loops, the surrounding dielectric material also affects the performance of the array. A multimaterial loop as the building block of a metasurface, consisting of number of concentric plasmonic loops with dielectric spacer layers, is one configuration that may be tuned by a large number of parameters. The concentric plasmonic loops can be designed to have minimum coupling in order to have different resonances far apart from each other. On the other hand one can take advantage of a design in which the coupling between the loop nanoantennas is enhanced and, therefore, features, such as Fano resonance and field intensity enhancement can be obtained. In other words for the high-coupled design there are two resonances with totally different features, one a very high Q mode, and the other a wideband radiating performance.

The performance of periodic array of multimaterial loops is described herein by means of the technique of finite-difference time-domain (FDTD) technique. First, a general Drude model for the plasmonic material is considered and resonance characteristics of a metasurface is obtained in terms of the loop parameters. Based on the obtained resonant permittivity and the Drude model function it is described herein how the resonant frequency would vary for different materials. These results were used to design two different configurations with respect to the coupling between the loops. The low coupled multimaterial loop metasurface is interpreted as a frequency selective surface with multiple bands in the transmission spectrum. Four different designs are considered to describe the resonance characteristics. In the first design by considering silver for the plasmonic loops material the procedure of designing a low-coupled multimaterial loop building block is shown. The effect of plasma damping factor on the resonance of the low-coupled design is illustrated by assuming gold as the inner loop material in the second design. Furthermore, changing the resonant frequency from short infrared to long infrared by choosing indium tin oxide (ITO) and aluminum-doped zinc oxide (AZO) for the plasmonic loop materials is investigated in the third design. The fourth design shows the capability of this building block in producing three different bands within the spectrum by using three low-coupled concentric loop nanoantennas. Described herein is how one can control the resonances by choosing each loop parameter properly. The field intensity enhancement on the surface of the loops is also described. The other arrangement is highly coupled plasmonic loops. In this configuration, contrary to the low-coupled design, each null or peak in the transmission or reflection performance is due to the near field interference of the concentric plasmonic loops. As a result the appearance of the dark and bright modes is shown. At the first resonance a large field intensity enhancement is shown that can be employed in order to enhance the nonlinear effects or the sensitivity of the performance to the surrounding media (Kivshar, 2008; Genevet et al., 2010; Isfahani et al., 2009). The second resonance exhibits a low-loss wideband phenomenon. The building block has a subwavelength size. The description of the characteristic of each resonance is based on the hybridization model proposed by Nordlander in Prodan et al., 2003, and the induced dipole moment of each plasmonic loop. The effects of spacer layer permittivity and loss on the performance of both designs is also described.

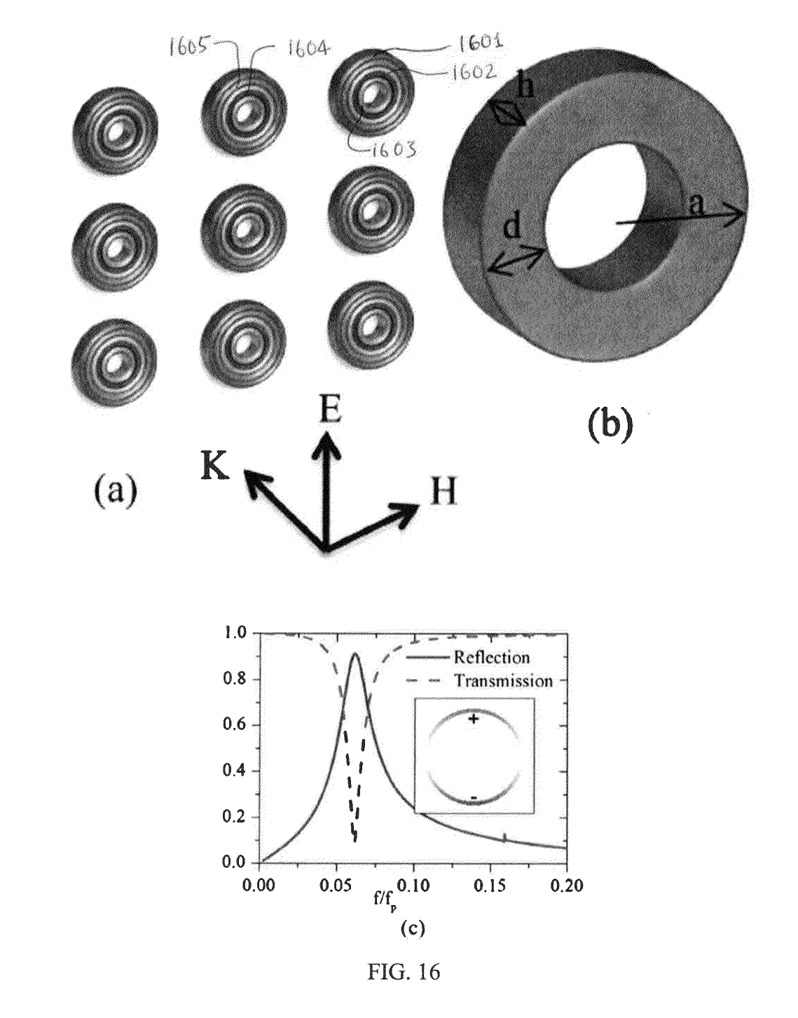

Array of single plasmonic loops as the simplest form of multimaterial loops: The metamaterial building block described herein, in general, is a multimaterial loop consisting of a number of concentric plasmonic loops with dielectric spacer layer in between as shown in FIG. 16A. The spacer layer dielectric is assumed to be free space unless stated otherwise. The periodic array of this building block is described with the full wave analysis method of the FDTD technique. Perfectly matched layers and periodic boundary conditions are used to terminate the computation boundaries (Taflove et al., 2005; Mosallaei, 2007). The Yee cell size is considered 2.5 nm for the designs with silver or gold and 13 nm for the designs with ITO or AZO. This choice of cell size makes the effect of FDTD staircase meshing negligible in modeling the loop shape. The general Drude model of ∈(ω)=∈_{∞}−ωₚ²/(ω²−jγₚω) is considered for the plasmonic materials. The simplest configuration of the multimaterial loops unit cell is a single plasmonic loop inside the free space. Three parameters of loop geometry dictate the resonant permittivity, and they are: radius (a), height (h), and thickness (d) as shown in FIG. 16B. The values for these parameters should be in accordance with the plasma frequency of the plasmonic material. Therefore, the loop parameters are normalized to the plasma wavelength of the general Drude model. In FIG. 16C the transmission and reflection coefficients of a periodic array of a single plasmonic loop nanoantenna is shown. The radius of the loop is 0.91λp, the height is 0.145λp, and the thickness is 0.07λp (λp is the plasma wavelength of the plasmonic material). The unit cell size of the square array is 2.175λp. The loop is excited with a plane wave with k-vector along the axis of the loop. A resonance occurs at f/f p=0.061, which corresponds to the first dipolar mode excited on the surface of the loop. The dimensions of the loop at the resonance are a=0.05λ, d=0.0045λ, and h=0.009λ, where λ is the resonant wavelength, which proves the subwavelength feature size of the elements. This is a purely electric resonance considering the fact that surface charges accumulate at both ends of the loop diameter parallel to the electric field excitation. The charge distribution on the surface of the loop at this resonant frequency shows the appearance of the dipole mode [inset of FIG. 16C]. The charge distribution on the surface of the loop is obtained with respect to the boundary conditions of normal displacement vector in Equation 3.

\hat{n}·(\vec{D}₂−\vec{D}₁)=ρₛ (3)

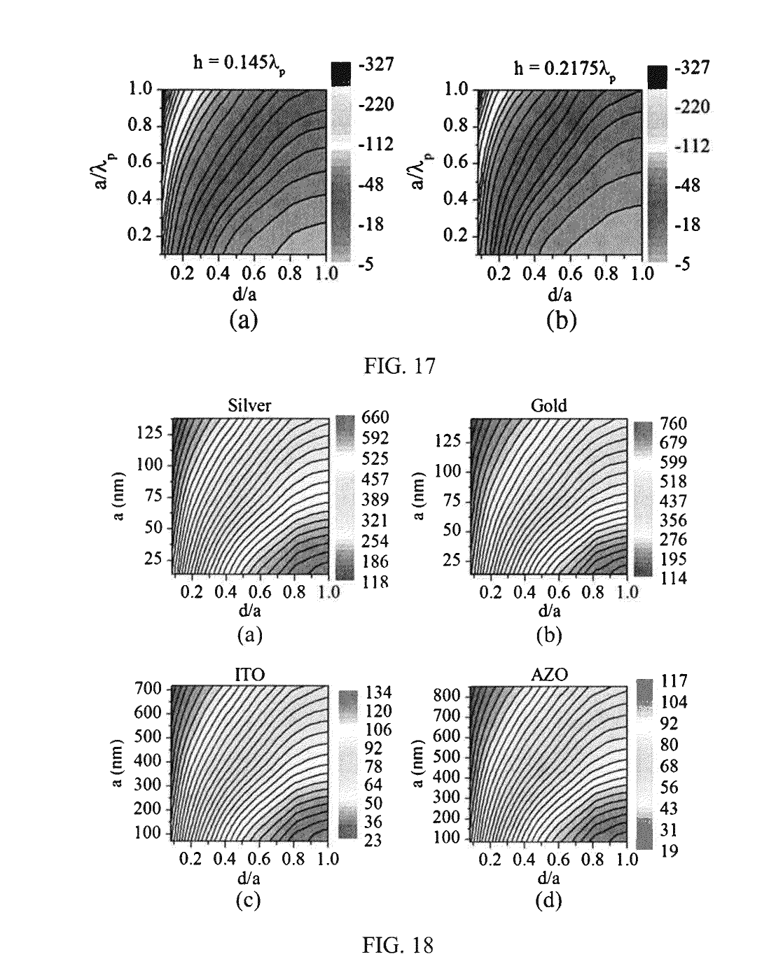

The aspect ratio of a loop, defined as the ratio of its thickness to its radius (d/a), is a parameter that can be engineered in order to control the resonant permittivity. For d/a=1 as the upper limit of the aspect ratio the geometry is a disk rather than a loop. According to (Ahmadi et al., 2011) for the disk geometry as long as 2 a/h>>1, the change in the resonant permittivity is very small for a change in the height of the disk. In FIG. 17 the resonant permittivity of a periodic array of single plasmonic loop is shown as a function of the loop radius and its aspect ratio. To show that under the condition of 2 a/h>>1, the height has minimal effect, resonance permittivity was evaluated for two different heights as shown in FIGS. 17A and 17B. In the following, the height of the multimaterial loops is considered to be 0.145 λp.

Described herein is a method of finding resonant permittivity to be able to find the resonant frequency for different materials. Due to the fact that the plasmonic loss does not affect the location of the resonant frequency much, the damping factor is assumed to be zero in the simulations carried out, the results of which are shown in FIG. 17. The inverse of the Drude model formula with damping factor equal to zero is the frequency as a function of the permittivity as shown in Equation (4).

$${f}_{res} = \frac{{f}_{p}}{\sqrt{{ɛ}_{∞} - {ɛ}_{res}}} \qquad ( 4 )$$

This equation gives us the approximate resonant frequency of the metasurface with respect to the plasma frequency of the loop's material. For different materials, based on their plasma frequency, this frequency can be located in widely separated regions of the spectrum. A more exact resonant frequency is derived from the full wave analysis after the loop parameters are chosen properly according to the design procedure.

Knowledge of the resonant frequency of an array of single plasmonic loop for different materials is helpful in designing a multimaterial loop metasurface with different characteristics as described in greater detail in the following. FIG. 18 shows the resonant frequency for four different materials, silver (ωₚ=1.36×10¹⁶, γₚ=2.73×10¹³), gold (ωₚ=1.30×10¹⁶, γₚ=1.11×10¹⁴), ITO (ωₚ=2.627×10¹⁵, γₚ=2.39×10¹⁴), and AZO (ωₚ=2.21×10¹⁵, γₚ=1.91×10¹⁴) (Johnson et al., 1972; Naik et al., 2011). According to each material's plasma frequency, the range of the loop radius, and the spectrum of the resonant frequency that has been swept for the results shown in FIG. 17-18 are different. The unit cell size of the periodic array changes accordingly as well. As an example the unit cell size of the design with silver and ITO as the loop material are considered to be 300 nm and 1.56 μm, respectively. In the following, based on the results obtained for resonant permittivity and frequency, multimaterial loop metasurfaces in two different categories, low coupled and high coupled, are designed. For accuracy, complete Drude model is considered, including the damping factor for the plasmonic materials.

Low-coupled multimaterial loops: The performance of a multimaterial loop metasurface can be predicted to some extend based on the response of each loop in the building block. When the resonances of the single loop metasurfaces are far apart from each other, the resonances do not overlap each other's bandwidth in the multimaterial loop configuration (concentric loops), and the coupling between the loops is small. Based on the results in FIG. 18 one could design such configuration by choosing the radius and the thickness of each loop such that the resonant frequencies are apart from each other. For two concentric loops the parameters of each loop could be chosen from either one of the curves in FIG. 18 or from two of them. The unit cell size of the array is a function of the plasma frequency of the loop material. As a result, for each material the unit cell size would be different. On the other hand, a small perturbation in the unit cell size has a negligible effect on the first resonant frequency. Therefore, as long as the plasma frequencies of the chosen materials for the building block are close, results shown in FIG. 18 may be used to design a low-coupled structure with two different materials, and the plasma frequency of either of the materials may be considered for defining the unit cell size.

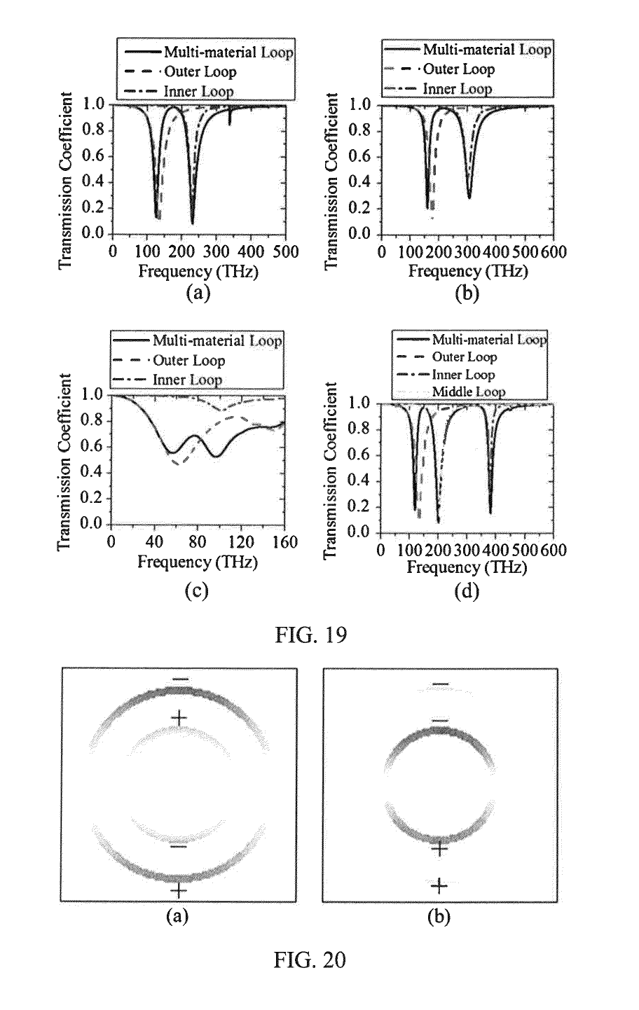

The performance of four different metasurfaces with low coupling is shown in FIG. 19. In the first design two plasmonic loops are made of silver. The radii of the outer and inner loops are 125 and 75 nm, respectively. The thickness of each loop is considered to be 10 nm. According to FIG. 18A the bigger loop resonates at around 134 THz while the smaller loop resonates at around 225 THz. The full wave simulation results of three metasurfaces of the outer loop, the inner loop, and the concentric loops are shown in FIG. 19A. The obtained resonant frequencies of the outer and inner loops by FDTD are 133.9 and 228 THz, respectively, which are very close to the predicted resonant frequencies. The concentric loop metasurface has two separate resonances close to the resonance of the individual loop arrays. It is observed that the first resonance mostly comes from the outer loop resonance while the second resonance is mainly due to the inner loop resonance.

FIG. 19B shows the performance of a multimaterial loop metasurface with two different materials. As long as the parameters are chosen properly for the two loops the same concept applies. Here silver is considered for the outer loop with radius of 100 nm and thickness of 10 nm. The unit cell size is considered based on the plasma wavelength of the silver, which is 300 nm. According to FIG. 18A the metasurface of this individual loop resonates at 176.5 THz. The inner loop is assumed to be gold with radius of 60 nm and thickness of 12.5 nm to resonate at 298 THz with according to the results shown in FIG. 18B. Due to higher loss of gold compared to silver, the resonance of gold is wider in bandwidth and less deep in amplitude. The obtained resonant frequencies of the outer loop and inner loop metasurfaces from FDTD are 176.8 and 301.6 THz, respectively. A good agreement is observed between the predicted resonant frequencies and the full wave simulation results. Through use materials like ITO and AZO instead of silver and gold it is possible to bring down the resonant frequency of the metasurface from near and short infrared to mid and long infrared. In FIG. 19C the performance of such a design is shown. In this design the outer loop is assumed to be ITO with radius of 624 nm and thickness of 312 nm. The metasurface of this ITO loop resonates at 62 THz according to FIG. 18C. The full wave analysis result shows the resonant frequency to be at 61.7 THz. For the inner loop the material is considered AZO with radius of 208 nm and thickness of 156 nm. The resonant frequency of this metasurface is 101 THz from FIG. 18D and 100.7 THz from FDTD results. Due to the high loss of both ITO and AZO, the resonances of the single loop array are wide in bandwidth. This provides a reason to separate the two resonances farther apart from each other at the first step when the parameters of the loops are chosen from FIGS. 18C and 18D to prevent the coupling between the two loops in the multimaterial loop building block. The design also provides the capability of having three or more separate resonances by designing the concentric loops properly. FIG. 19D illustrates the performance of three concentric loops made of sliver with radii of 125, 85, and 40 nm, with the thickness of 10 nm. Based on the first assumption for the unit cell size of the periodic array, and the height of the loops, it is considered that T=2.175λₚ(silver)=300 nm and h=0.145λₚ(silver)=20 nm for the designs of FIGS. 19A, 19B, and 19D and T=2.175λₚ(ITO)=1.56 μm and h=0.145λₚ(ITO)=104 nm for the design in FIG. 19C. In the following, to reduce the effect of loss, silver is considered for the multimaterial loop metasurface.

Comparison of the performance of single loops to multimaterial loops with low coupling between the loops in FIG. 19 illustrates that the first resonance in the two concentric loops design is narrower in bandwidth compared to the single outer loop resonance. At this resonance the dipole moments induced on each loop are antiparallel as shown by the surface charge distribution on the loops in FIG. 20A. Therefore, the net dipole moment decreases at this resonance and results in decreasing the bandwidth of the resonance. Compared to the outer loop metasurface, localized field intensity enhancement and larger sensitivity to the surrounding media permittivity are the consequences of the subradiant nature of this resonance. On the other hand the second resonance has a wider bandwidth compared to the single inner loop resonance. As shown in FIG. 20B, the parallel dipole moments of each loop increases the net dipole moment of the second resonance. As a result the bandwidth of the resonance is enhanced and it has a superradiant character with lower field enhancement and lower sensitivity to the surrounding media compared to the single inner loop metasurface.

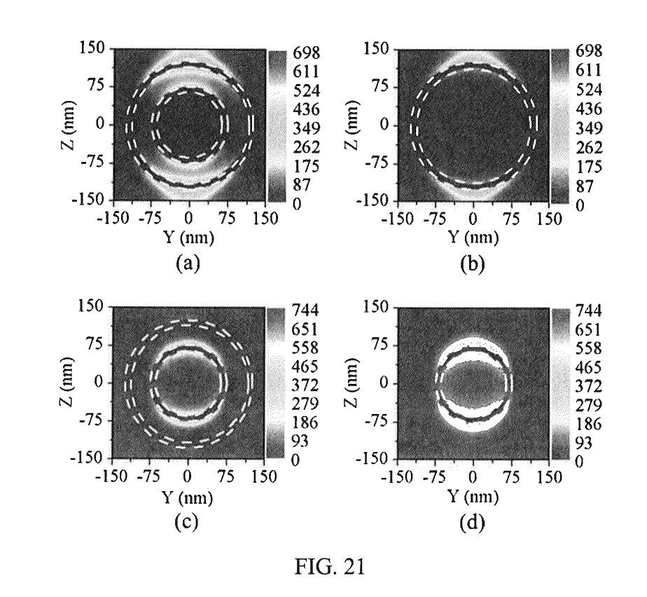

A high-intensity localized field is a known characteristic of a subwavelength plasmonic particle resonance. FIGS. 21A and 21C are the field distribution at the first and second resonances of the low-coupled design in FIG. 19A, respectively. The field distribution of the multimaterial loop metasurface is compared herein with an array of a single plasmonic loop. Because the first resonance is due to the outer loop resonance, and the second resonance originates from the inner loop, FIG. 21A is compared to the field distribution of the array of the outer loop in FIG. 21B, and FIG. 21C is compared to the field distribution of the array of the inner loop in FIG. 21D. The electric field intensity is calculated in the plane perpendicular to the axis of the loop and at the middle of the loop's height. Due to the low coupling of the two concentric loops at the first resonance the field is mostly localized on the outer loop, while at the second resonance the inner loop surface has the localized field on itself. The subradiant character of the first resonance is observed here in the higher field localization at the first resonance compared to the single outer loop array. Also the lower electric field localization at the second resonance compared to the inner loop array is an evidence for the superradiant characteristic of the second resonance.

High-coupled multimaterial loops: As long as the coupling between the loops is small each resonance can be controlled by changing the corresponding loop's aspect ratio. From FIG. 18 it can be seen that by increasing the aspect ratio of the loop the resonant frequency will have a blue shift. Considering now that the inner loop geometry is fixed and the aspect ratio of the outer loop is gradually increased by increasing its thickness. If the blue shift of the first resonance is large enough so that the second resonance happens to be in the bandwidth of the first resonance, then the prerequisite of Fano resonance is achieved. This enhances the coupling between the two loops dramatically and results in the appearance of a dark mode with vanishing net dipole moment and a bright mode with a superradiant characteristic that has radiating wideband profile (Wu et. al., 2011; Hao et al., 2009; Fan et al., 2010, Nano Lett.; Fan et al., 2010, Science; Luk'yanchuk et al., 2010; Sancho-Parramon et al., 2012). To design a high-coupled multimaterial loop metasurface, using FIG. 18, the geometry of the two loop nanoantennas are chosen such that the resonant frequencies of the individual loop arrays are close to each other. In contrast, with the low-coupled multimaterial loops the resonances of the multimaterial loop metasurface do not resemble the resonance of each loop, and are based on the near field interaction of the concentric loops.

Two loops of silver with radii of 125 and 75 nm and thicknesses of 30 and 10 nm for the outer and inner loops, respectively, are considered next. The two arrays of the outer and inner loops resonate at 215 and 225 THz, respectively. The transmission coefficient of the multimaterial loop metasurface as well as each individual loop array is shown in FIG. 22A. In the transmission coefficient there are two null and a sharp peak in between that are labeled by (I), (II), and (III). The charge distribution at each of these resonances (as shown in FIGS. 22B-22D) along with the net dipole moment calculated from Equation (5) affords to a better understanding of the characteristics of each of these three frequencies:

$$\vec{P} ( \vec{r} ) = {\int }_{V}^{ } ρ ( {\vec{r}}_{0} ) ( {\vec{r}}_{0} - \vec{r} ) {d}^{3} {\vec{r}}_{0} \qquad ( 5 )$$

At the first transmission null labeled by (I) likewise the first resonance of the low-coupled design, the induced dipole moments on the loops are antiparallel. In this case the inner loop dipole moment reduces the net dipole moment more significantly compared to the low-coupled design. By moving toward higher frequency the amplitude of the inner and outer loop dipole moment becomes closer while still remaining antiparallel. As a result the dark mode (II) with almost zero net dipole moment appears between the two nulls in the transmission coefficient (the wave can pass through). Due to their subradiant nature, these two frequencies have the characteristics of high field intensity and large sensitivity to the surrounding media. The second null in transmission coefficient or the bright mode (III) has a wideband feature due to the fact that the dipole moments induced on the surfaces of the outer and inner loops are in parallel. This is a very unique feature. The superradiant characters such as low field enhancement and high scattering are attached to this resonance. At all three modes, the building block has a subwavelength size.

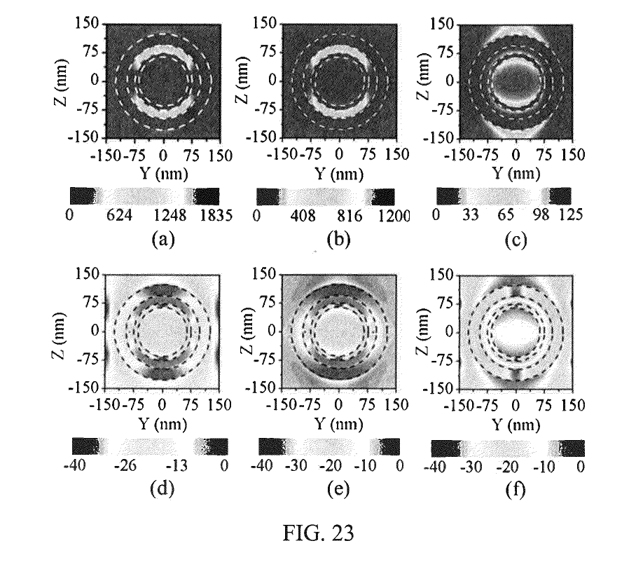

The localized electric field intensity can be considerably enhanced by taking advantage of the high coupling between the loops. For the design in FIG. 22 the electric field intensity distributions at three frequencies of (I), (II), and (III) are shown in FIG. 23 FIG. 8 both in (V/m)² and dB. FIGS. 23A and 23D show the electric field intensity distribution at frequency (I). At this subradiant mode the electric field is mostly confined within the spacer layer due to the antiparallel dipole moments of the inner and outer loops. Moreover, there is some field localization on the external surface of the outer loop with lower intensity because of the nonvanishing net dipole moment at this frequency. The electric field intensity distribution at frequency (II) are shown in FIGS. 23B and 23E. At this frequency the field is just confined within the spacer layer with no field outside of the outer loop. This behavior can be explained by the zero net dipole moment at this frequency. Considering the small volume and the very large intensity of the electric field this can be used to enhance the nonlinear effects. Also this results in greater sensitivity to the spacer layer permittivity, which can be used in optical sensing. In addition, according to the high transmission coefficient at this frequency the energy is transmitted through the spacer layer and electromagnetically induced transparency is achieved (Papasimakis et al., 2009). On the other hand, at frequency (III) the field is localized mostly on the surface of the outer loop (FIGS. 23C and 23F, and according to the superradiant characteristic of this resonance, the intensity of the localized field is much lower than in the other two frequencies. This is in fact the main reason for having a wideband performance at this frequency (shown in FIG. 22A).

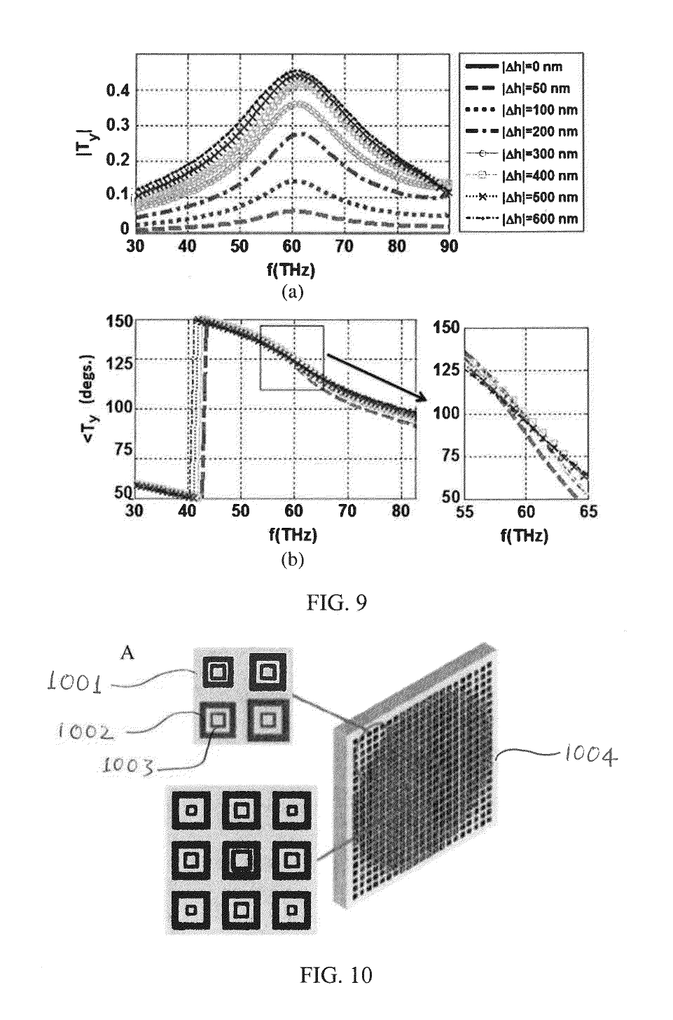

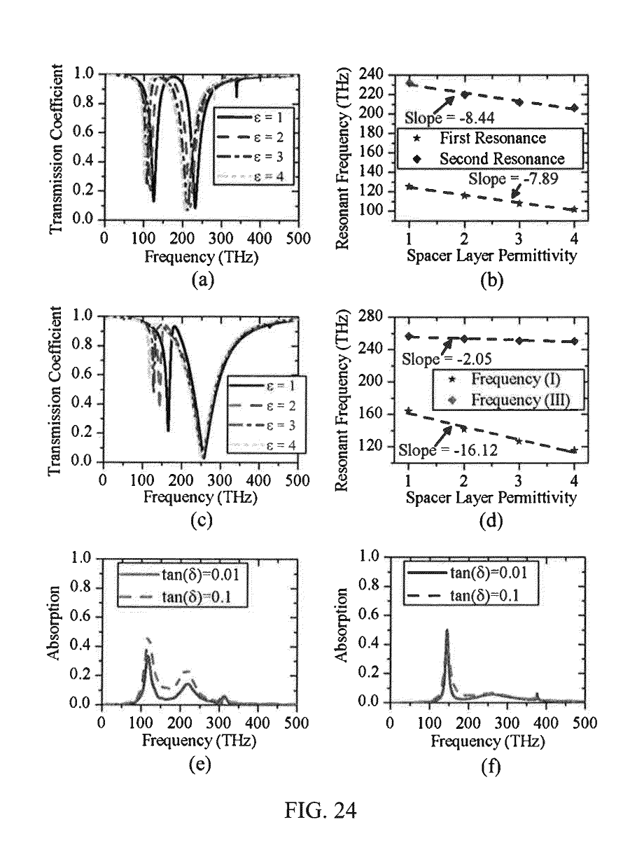

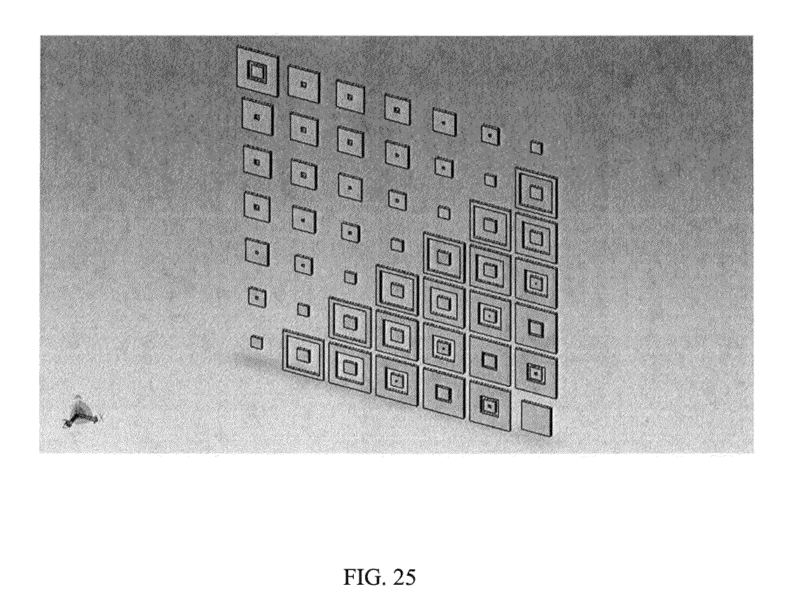

Effect of spacer layer permittivity and loss: In multimaterial loop design one can use a proper dielectric material between the plasmonic loop nanoantennas to control the resonance characteristics in desired ways. Resonances with a high quality factor exhibit more sensitivity to the perturbations compared to low quality factor resonances. On the other hand, the permittivity of the spacer layer is much more effective in changing the resonant frequency if the field is localized within the spacer layer. As a result the high-coupled multimaterial loop metasurface should undergo more significant changes compared to the low-coupled design for the same amount of perturbation in the spacer layer permittivity. Also, for the high-coupled design due to the fact that the field is localized within the spacer layer at the first null (I) and the first peak (II) in transmission coefficient, these two frequencies are much more sensitive to the spacer layer permittivity than the second null (III) in the transmission coefficient. In order to show these effects, the spacer layer permittivity is swept between 1 and 4 in simulations herein for the two designs in FIG. 19A (low-coupled) and FIG. 22 (high-coupled). For the low-coupled design, as illustrated in FIG. 24A FIG. 9(a), both resonances experience red shifts. A line was fitted on the change in the first and second resonance frequency as a function of the spacer layer permittivity (FIG. 24B). The slopes of both lines are close to each other. For the high-coupled case (shown in FIG. 24C) the first null (I) and the peak (II) experience significant changes due to both the high quality factor of the resonance and also the localization of the fields within the spacer dielectric layer. The slope of the change in resonant frequency (I) versus the spacer layer permittivity is twice that for the low-coupled case. In contrast, the frequency of the second null (III) does not change considerably by perturbing the spacer layer permittivity due to the superradiant character and also the weak field intensity within the spacer layer.

The absorption performance of the system is also described. Two cases for the permittivity of spacer layer, ∈ᵣ=2+j0.02 and ∈ᵣ=2+j0.2 are considered. The results for low- and high-coupled cases are shown in FIGS. 24E and 24F, respectively. Increasing the loss of spacer layer will increase the absorption in the system, unless for the second transmission null for the high-coupled case. This phenomenon is interesting because the loss at this frequency is minimum in comparison to that for other designs. Specifically, for the resonances that there are strong localized fields within the spacer layer the loss in permittivity will affect the absorption greatly. But for the second null of a high-coupled case the field is not localized and as such the design is not sensitive to the loss. As a result a subwavelength building block is achieved with wideband and low loss characteristics. The high coupled design offers the advantage that there are two resonance phenomena with totally different characteristics. At the first resonance, which is characterized as subradiant, changing the spacer layer permittivity from 1 to 2 according to FIG. 24C, the first resonant frequency changes from 165 to 142 THz. Consequently, the transmission coefficient at 165 THz is changes from 92% to 22%, which makes the multimaterial loop according to the design herein an ideal candidate for sensing applications. On the other hand the second resonance has a wide bandwidth with low loss due to its superradiant character.

Another embodiment of the invention, as described below, is a metasurfaces that enables tailoring the transmission amplitude and phase profiles of incident light independent of each other.

First, the capabilities of a metasurface with arbitrarily defined amplitude and phase profiles is described. In general, the input and output beams of a linear space invariant (LSI) system are related by

φₜ(x,y)=tₛ(x,y)*φᵢₙ(x,y) (6)

where φᵢₙ(x, y) and φₜ(x, y) are the profiles of the incident and transmitted beams, tₛ(x, y) is the impulse response of the system, and * denotes convolution. Emphasizing that tₛ(x, y) is space invariant, Equation (6) transforms to Equation (7) in the Fourier domain

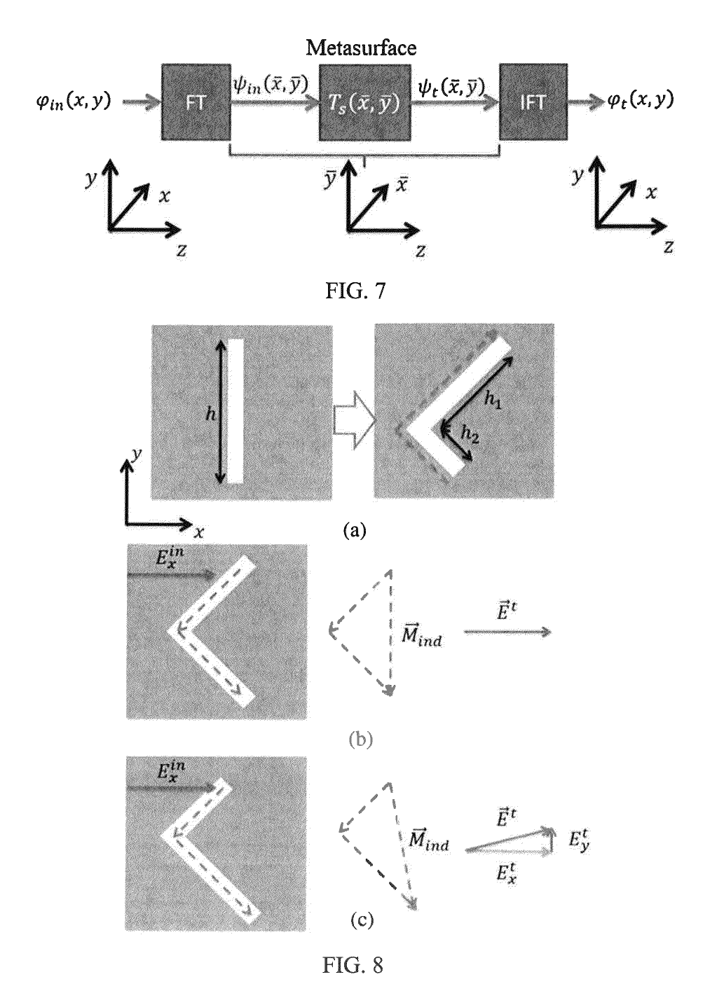

ψₜ( x̅, y̅)=Tₛ( x̅, y̅)ψᵢₙ( x̅, y̅) (7)

where ψₜ( x̅, y̅), Tₛ( x̅, y̅) and ψᵢₙ( x̅, y̅) are the Fourier transforms (FT) of their counterparts in Equation (6), respectively, and ψᵢₙ( x̅, y̅) denotes 2D Fourier domain variables. Equation (7) is identical to the relation governing the incident beam, transmitted beam, and transfer function of a metasurface. Therefore, FT and inverse FT (IFT) blocks can be used along with the appropriate metasurface, to realize any LSI system (see FIG. 7). Spatial FT and IFT blocks are achievable using flat gradient index (GRIN) lenses (Gomez-Reino et al., 2002; Vakil et al., 2012).

As a result, manipulation of the transmission amplitude and transmission phase independent of each other enables production of a metasurface with arbitrary Tₛ( x̅, y̅), which makes it possible to develop unique LSI operations. Nanoantennas previously designed cannot be utilized to independently manipulate both amplitude and phase at the same time. However, metallic concentric loops on a dielectric substrate can tune transmission phase with a fixed amplitude (Memarzadeh and Mossalaei, 2011). By adding another nanoantenna capable of tuning the amplitude alone, it is possible to achieve independent amplitude and phase adjustment. Such antenna is described below.

Tuning transmission amplitude using a L-shaped slot: A resonant, narrow rectangular slot in a thin metal film is first considered. At resonance, the transmission is maximum. As the slot length is changed, both transmission phase and amplitude change at the same time. To bypass this inherent amplitude/phase dependency, the geometry of the rectangular slot is modified to a 45° rotated L-shaped slot, as shown in (FIG. 8A). It is possible to achieve constant transmission phase by keeping the resonance length, h=h₁+h₂, fixed. The transmission amplitude is then tuned, independent of the phase, by changing each h₁ and h₂ (the arms' lengths).

To provide physical insight for the above statement the induced currents and scattered fields are examined in detail. It is assumed that the L-shaped slot is illuminated with a normal x-polarized electric field. The incident electric field induces a fictitious magnetic current

\vec{M}_{ind}=\vec{E}_{ind}×\hat{n} (8)

where \vec{M}_{ind} is the induced magnetic current in the L-shaped slot arms and \hat{n} is the unit vector normal to the surface (\hat{z} in FIG. 8). The scattered electric field encircles the magnetic current source similar to magnetic fields encircling the electric current. Therefore, a y-directed M will radiate an x-directed electric field in the x=0 plane and vice versa.

If h₁=h₂ (symmetric arms), Mₓ in the two arms completely cancel, and M_{y} will radiate Eₓ (FIG. 8B). On the other hand, if h₁≠h₂, Mₓ will not vanish and a y-directed electric field will be reradiated (FIG. 8C). As h₁ is increased (h₂ is decreased), the amplitude of the radiated Eₓ will decrease while the amplitude of E_{y} will increase. The transmission phase delay will remain the same since the total slot length fixed. As a result, the amplitude of the transmitted wave (both y and x components) can be swept keeping the transmission phase delay constant. In the above, the magnetic current distribution along slot length was assumed to be uniform for the sake of simplicity. In reality, the current magnitude is larger at the center of the slot. However, the same reasoning is still applicable.

As the L-shaped slot geometry is changed between the symmetric arms and a 45° slanted slot, the transmitted Eₓ value decreases to half and E_{y} increases from zero to half of the incident Eₓ. Hence, the scattered E_{y} offers a wider range of relative amplitude variations. The unwanted polarization can be filtered out by a suitable polarizer.

To demonstrate the control over amplitude, local periodicity was assumed and the unit cell of the L-shaped slot shown in FIG. 8 was simulated using a 3D finite-difference time-domain (FDTD) solver from Lumerical, Inc. (Vancouver, Canada). The unit cell size is 1 μm and the metal film is a 50 nm thick silver. Lumerical uses Palik's experimental data (Palik et al., 1985) to model metals such as silver in the infrared range. The background dielectric refractive index and the operation wavelength is assumed to be 3.15 and 5 μm, respectively.

The structure is illuminated with an x-polarized plane wave and the scattered/transmitted fields are monitored. FIG. 9 depicts the amplitude and phase variations of the scattered E_{y} versus frequency for different values of Δh=|h₁−h₂|. As shown, the relative amplitude of the scattered E_{y} changes from 0 to 0.45, while the phase varies by less than 10° (at 60 THz). Similar behavior is observed for the transmitted x-polarized field. However, relative variations in its amplitude are not significant compared to the y-polarized field. A 180° transmission phase shift can be achieved by mirroring the L-shaped slot with respect to the x axis (or, equally replacing h₁ with h₂ and vice versa).

It is emphasized that the fictitious magnetic current scatters E_{y} equally to both sides of the thin metal film. At the same time, reflected Eₓ is small (in average, reflected Eₓ carries 10% of the incident power).

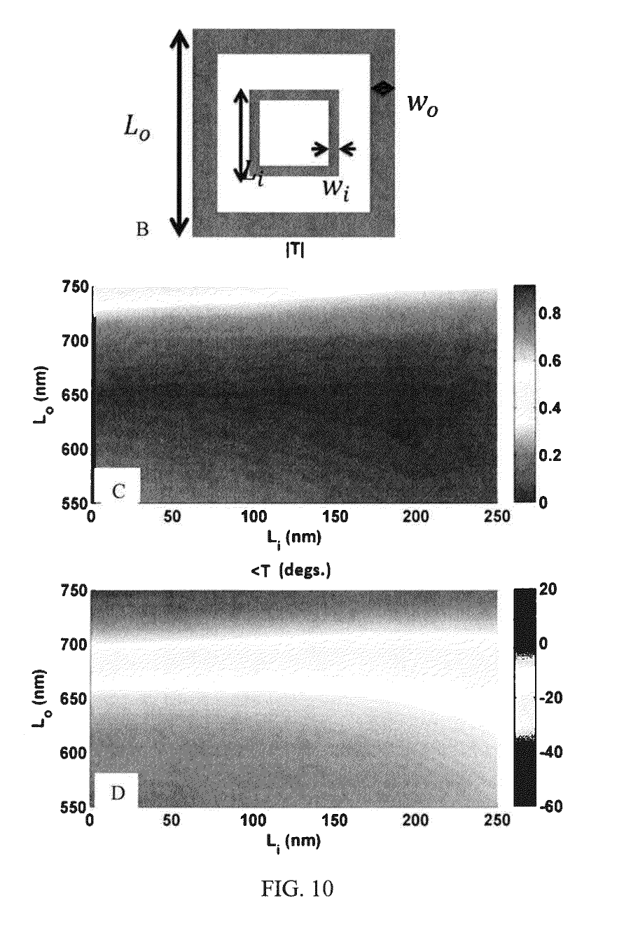

Tuning transmission phase using concentric loops: FIG. 10B shows a unit cell consisting of concentric loops for controlling transmission phase while keeping the amplitude constant according to Memarzadeh and Mosallaei, 2011. A range of transmission phase delays can be obtained by changing the size of the inner and outer loops (Lᵢ and Lₒ), leaving the transmission amplitude virtually unaffected. The software Lumerical is used to simulate a unit cell designed to work at 5 μm (60 THz). The unit cell size is 1 μm and the background material refractive index is 3.15. The simulated transmission amplitude and phase for different values of Lᵢ and Lₒ are shown in FIGS. 10C and 10D. With a 10% percent amplitude variation tolerance, the phase delay changes by 45°. Two or more concentric loop unit cells can be cascaded to produce higher phase delay variations.

Tuning amplitude and phase independently in a hybrid cell—The feasibility of cascading the proposed L-shaped slot unit cell and the concentric loops to produce a double-layered unit cell that controls the amplitude and phase independently is described next. The spacing between the two unit cells should be large enough to mitigate the mutual coupling effect.

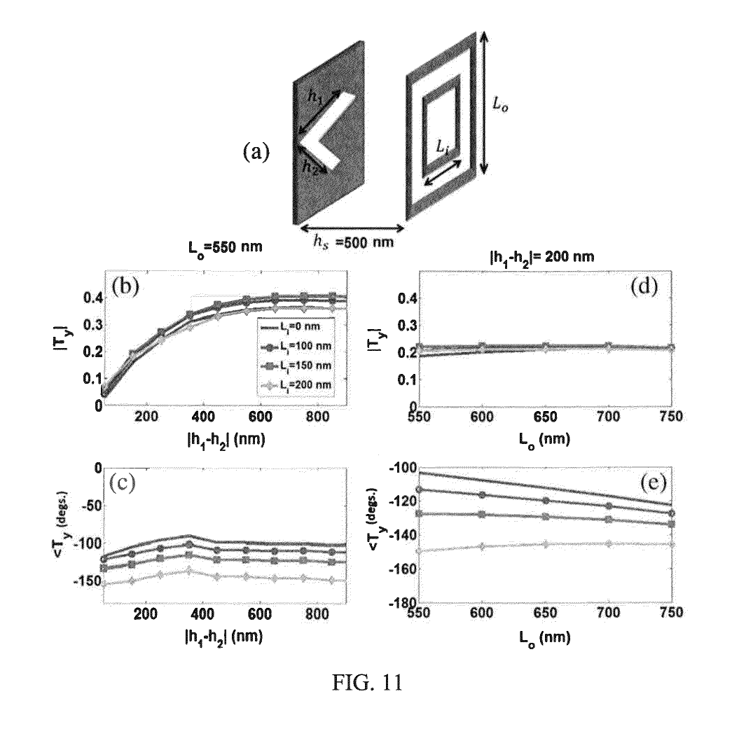

A cascaded unit cell of the two aforementioned nanoantennas is shown in FIG. 11A. Simulation results show the mutual coupling effect can be ignored with spacing of 500 nm (λ₀/10) or larger in a background material with n=3.15.

Amplitude and phase of the transmitted beam is then controlled by three parameters, |h₁−h₂|, Lᵢ and Lₒ. The phase variation is mainly determined by Lᵢ and Lₒ and |h₁−h₂| dominantly controls the amplitude. The cascaded unit cell is simulated for different values of geometrical parameters, and the transmission amplitude and phase are observed. (See FIGS. 11B-11E).

FIG. 11B illustrates amplitude changes as a function of |h₁−h₂| with Lᵢ as a sweeping parameter. The transmission amplitude varies considerably with the L-shaped slot parameter, |h₁−h₂|. The curves for different values of Lᵢ coincide. In FIG. 11C, the changes in transmission phase delay are negligible against |h₁−h₂|, while it shifts considerably with Lᵢ. The transmission amplitude is essentially insensitive to Lₒ and Lᵢ as revealed in FIG. 11D, while both loop parameters affect transmission phase as presented in FIG. 11E.

This cascaded unit cell establishes a building block to control amplitude and phase independently. An array of these building blocks in a graded-pattern may be used to realize any desired transfer function as described below.

A portion of the results described above has been published as the articles: (a) Birefringent reflectarray metasurface for beam engineering in infrared, Optics Letters Vol. 38: 4, pp. 462-464, (2013) by authors Mohsen Farmahini-Farahani and Hossein Mosallaei; (b) Multimaterial loops as the building block for a functional metasurface, J. Opt. Soc. Am. B, Vol. 30:7, pp. 1827-1834, (2013) by authors Babak Memarzadeh and Hossein Mosallaei; and Metasurfaces nanoantennas for light processing, J. Opt. Soc. Am. B, Vol. 30:9, pp. 2365-2370, by authors Mohsen Farmahini-Farahani and Hossein Mosallaei. All three articles are hereby incorporated herein by reference in their entireties.

The invention having now been fully described, is exemplified by the following examples and claims which are for illustrative purposes only and are not meant to be further limiting.

The examples demonstrate that the metasurfaces having nanoantannas described here clearly have the ability to control both amplitude and phase locally, desirably, and independently. In the model described here, the L-shaped slot tailors the amplitude and the concentric loop engineer the phase. Cascading these two metasurfaces (having graded pattern) makes it possible to construct devices for performing mathematical functions, thereby making “flat optics” engineering a reality. Double layered metasurfaces may be constructed to synthesize desired transmission amplitude and phase profiles, and achieve mathematical operations of interest, as required by application.

While a double layer configuration where one layer is an amplitude modulator and the other a phase modulator is described herein, it is possible to perform both amplitude and phase modulation in the same layer to achieve a higher amplitude/phase change. The presented graded metasurfaces can be realized by patterning the metallic films with the standard nanofabrication technology.

### EXAMPLES

### Example 1

### Metasurface with Multiplication Functionality

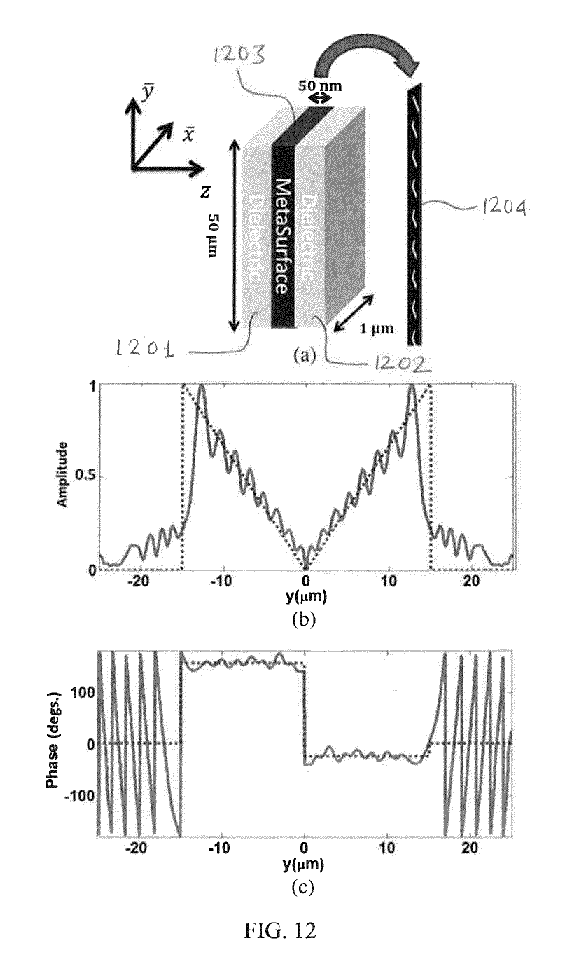

A metasurface is described below to perform multiplication by y̅. For simplicity, a two dimensional case is considered in which the wave propagates along the z direction and the metasurface structure is periodic along the x direction. A rectangular pulse is selected as the spatial distribution of the incident wave. The spatial width of the pulse is 30 μm. A graded metasurface of 15 L-shaped slots along the y direction at positions from y=1 to y=15 μm is designed. The values of h₁ and h₂ for each of these nanoantennas are obtained from FIG. 9A to realize Tₛ( y̅)∝ y̅. The structure is mirrored with respect to the x axis for the negative values of y. Table 1 shows the dimensions of the L-shaped slot antennas. FIG. 12A shows a part of the designed metasurface sandwiched between the two dielectric layers. The metasurface is setup in Lumerical and illuminated with the 30 μm wide rectangular pulse. The normalized output beam amplitude and phase were monitored and are shown in FIGS. 12 B and 12C and compared to the theoretically obtained values.

TABLE 1
Dimensions of L-shaped slots used to realize spatial derivation functionality

| No. | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| h₁ | 500 | 525 | 535 | 545 | 555 | 565 | 575 | 590 | 600 | 615 | 630 | 650 | 680 | 725 | 1000 |
| nm | | | | | | | | | | | | | | | |
| h₂ | 500 | 475 | 465 | 455 | 445 | 435 | 425 | 410 | 400 | 385 | 370 | 350 | 320 | 275 | 0 |
| nm | | | | | | | | | | | | | | | |

The comparison reveals that the metasurface performs multiplication by y̅. There is good agreement between simulation and theory in the middle area of the metasurface, and there is mismatch at the edges since the local periodicity assumption does not hold at the edges. For practical purposes, the x-polarized component can be filtered out by a linear polarizer. Tailoring the amplitude with a passive structure inherently decreases the efficiency. The maximum transmitted y-polarized component is 42%, as shown in FIG. 9A.

### Example 2

### Metasurface with Differentiation Functionality

The application of the L-shaped slot nanoantennas in realizing spatial derivation functionality is considered below. The conceptual implementation of signal processing operations like differentiation and convolution based on metamaterials has been described by Engheta, 2012. Spatial differentiation is achieved by multiplying by i y̅ in the Fourier domain. The unit cell of the L-shaped slot described above can perform this multiplication.

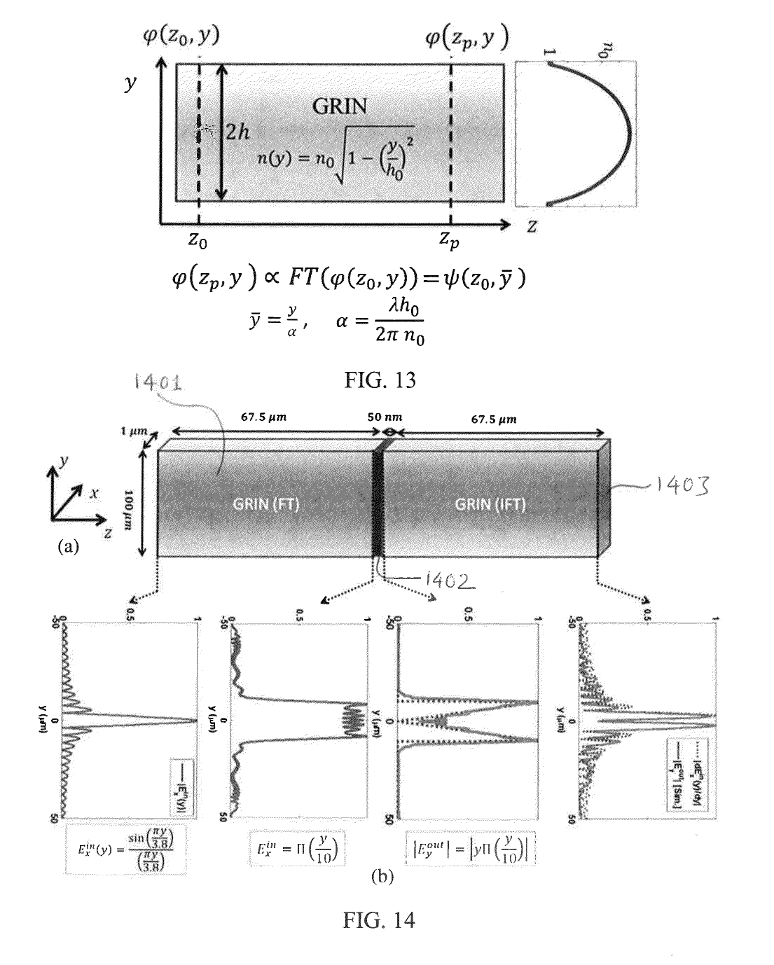

To obtain the differentiation functionality FT and IFT blocks are added to the realized metasurface (see FIG. 7) used for multiplication. An FT (IFT) block is realized by GRIN (gradient-index) flat lenses. (Gomez-Reino and Bao, 2002). The GRIN flat lenses are fabricated by drilling subwavelength air holes on a dielectric slab. (Mei et al., 2010). FIG. 13 shows a GRIN material with refractive index profile

n(y)=n₀\sqrt{1−(y/h₀)²} (9)

The structure is infinite in the x direction and the input beam travels in the z direction. After traveling a distance of zₚ−z₀=πh₀/2, the beam profile φ(zₚ,y) is proportional to spatially scaled FT of the beam at z₀ψ(z₀, y̅). The details are given in FIG. 13 and Gomez-Reino et al., 2002. y̅ still represents a spatial position, though it denotes the Fourier domain variable. In other words, the FT of the input beam profile is formed after traveling a distance of πh₀/2, scaled in the y axis by α.

The differentiator is shown in FIG. 14A. The two GRIN parts implement FT and IFT and the metasurface in between performs multiplication by i y̅. For this case, n₀=3.3, h₀=50 μm which gives zₚ−z₀=67.5 μm.

The FDTD mesh for the metasurface is fine enough (dₓ=dy=12.5 nm) to resolve the small features in L-shaped slot unit cells. Due to small mesh size, the simulation becomes computationally prohibitive. Therefore, a block-by-block approach is adopted here to carry out the simulation. The first FT block is excited with the input beam profile. The output of this block is monitored and used as excitation for the metasurface block. Then, the metasurface output is monitored and sourced into the third block.

The incident beam in the interface of the FT block and metasurface spans only 20 μm around y=0 where the index changes from 3.3 to 3.23. The maximum reflection between GRIN lenses with the profile defined by Equation (9) and the background material of the metasurface with n=3.15 interface is 0.023, which is negligible. Therefore, performing block-by-block simulation is valid.

The Sinc function is selected as the input beam profile. The first GRIN block in FIG. 14A gives a rectangular pulse, which is the FT of a Sinc function. The same metasurface as shown in FIG. 12 is used here to perform i y̅ multiplication. The second GRIN performs the IFT, producing the derivative of the Sinc function at the output.

This structure is simulated using Lumerical and the output of each block is shown in FIG. 14B. The simulated IFT output wave profile is in agreement with the derivative of a Sinc function for the main lobes in the center. Aside from the errors originating from the metasurface, the discrepancy between the two in the far side lobes is due to the imperfect IFT block. The GRIN lens performs well when index variations are small over a wavelength. As the index profile in FIG. 13 reveals, this is not the case at the edges.

The unit cell of the L-shaped slots and concentric loop was designed with a background material having a refractive index equal to 3.15, which is easily embeddable in the GRIN blocks. Nevertheless, the design concept can be implemented standalone or on a dielectric substrate without any loss of generality.

### Example 3

### Metasurface for Beam Synthesis

Another exemplary device comprising the metasurface that enables tailoring the transmission amplitude and phase profiles of incident light independent of each other is the beam synthesis metasurface described below. The metasurface is configured to synthesize triangle envelope amplitude and phase when illuminated with a rectangular pulse. For each unit cell configuration, the desired amplitude and phase are obtained independently from the data provided in FIGS. 9 and 10. Concentric unit cells are tuned slightly to compensate for the undesired phase delays induced by the L-shaped slots where needed.

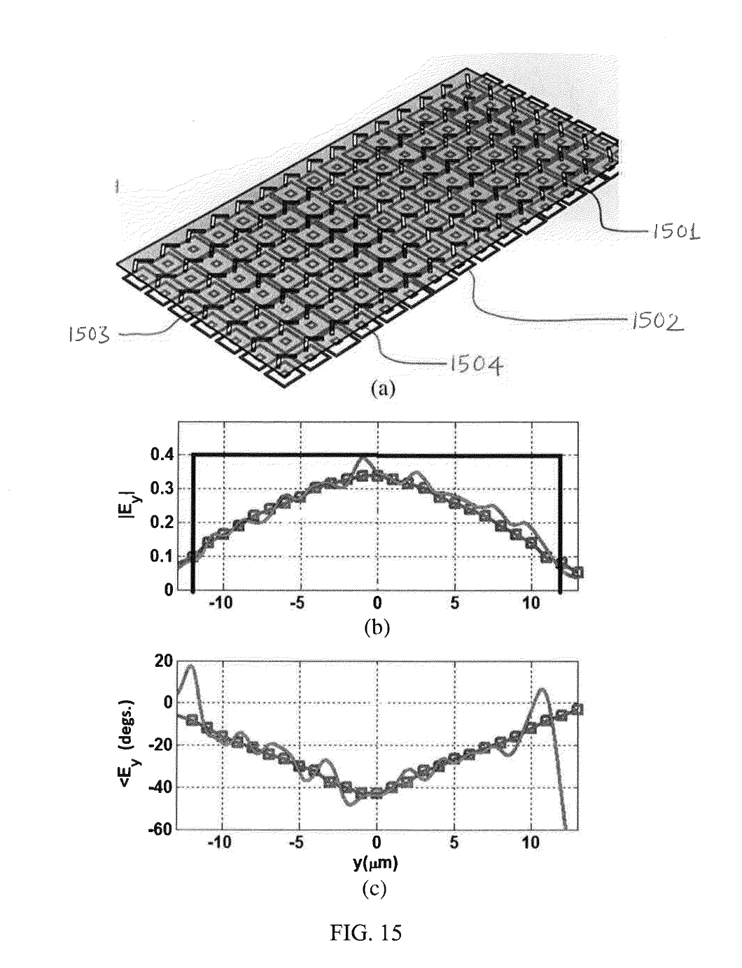

A part of the double-layer graded metasurface realizing triangle phase and amplitude is shown in FIG. 15A. The metasurface is excited with a 24 μm wide rectangular pulse. Triangular waveforms are expected for both amplitude and phase of the output wave. The output amplitude and phase are depicted in FIGS. 15B and 15C, respectively, and both show triangular wave forms. The maximum error is less than 7° in the phase curve except for the unit cells at each end of the array. The discrepancy between the designed phase and simulated one at the edges is attributed to both the small input amplitude and diffraction from the edge of the array.

### REFERENCES

A. Ahmadi, S. Ghadarghadr, and H. Mosallaei, “An optical reflectarray nanoantenna: the concept and design,” Opt. Express 18, 123-133 (2010).
A. Ahmadi, S. Saadat, and H. Mosallaei, “Resonance and Q performance of ellipsoidal ENG subwavelength radiators,” IEEE Antennas Propag. Mag. 59(3), 706-713 (2011).
J. Aizpurua, P. Hanarp, D. S. Sutherland, M. Käll, G. W. Bryant, and F. J. García de Abajo, “Optical properties of gold nanorings,” Phys. Rev. Lett. 90, 057401 (2003).
C. F. Bohren and D. R. Huffman, “Absorption and scattering by a sphere,” in Absorption and Scattering of Light by Small Particles (Wiley-VCH, 1998), pp. 82-129.
E. Carrasco and J. Perruisseau-Carrier, “Reflectarray antenna at terahertz using graphene,” IEEE Antennas Wireless Propag. Lett. 12, 253-256 (2013).
J. I. L. Chen, Y. Chen, and D. S. Ginger, “Plasmonic nanoparticle dimers for optical sensing of DNA in complex media,” J. Am. Chem. Soc. 132, 9600-9601 (2010).
U. K. Chettiar, R. F. Garcia, S. A. Maier, and N. Engheta, “Enhancement of radiation from dielectric waveguides using resonant plasmonic coreshells,” Opt. Express 20, 16104-16112 (2012).
N. Engheta, “Functionalizing metamaterials as metasystems,” presented at 2012 MRS Fall Meeting and Exhibit, Boston, Mass., Nov. 27, 2012.
J. A. Fan, C. Wu, K. Bao, J. Bao, R. Bardhan, N. J. Halas, V. N. Manoharan, P. Nordlander, G. Shvets, and F. Capasso, “Selfassembled plasmonic nanoparticle clusters,” Science 328, 1135-1138 (2010).
J. A. Fan, K. Bao, C. Wu, J. Bao, R. Bardhan, N. J. Halas, V. N. Manoharan, G. Shvets, P. Nordlander, and F. Capasso, “Fanolike interference in self-assembled plasmonic quadrumer clusters,” Nano Lett. 10, 4680-4685 (2010).
M. Farmahini-Farahani and H. Mosallaei, “Birefringent reflectarray metasurface for beam engineering in infrared,” Opt. Lett. 38, 462-464 (2013).
V. E. Ferry, J. N. Munday, and H. A. Atwater, “Design considerations for plasmonic photovoltaics,” Adv. Mater. 22, 4794-4808 (2010).
P. Genevet, J.-P. Tetienne, E. Gatzogiannis, R. Blanchard, M. A. Kats, M. O. Scully, and F. Capasso, “Large enhancement of nonlinear optical phenomena by plasmonic nanocavity gratings,” Nano Lett. 10, 4880-4883 (2010).
J. C. Ginn, B. A. Lail, and G. D. Boreman, Antennas and Propagation Society International Symposium 2006 (IEEE, 2006), pp. 4315-4318.
J. C. Ginn, B. A. Lail, and G. D. Boreman, IEEE Trans. Antennas Propag. 55, 2989 (2007).
J. Ginn, B. Lail, J. Alda, and G. Boreman, Opt. Lett. 33, 779 (2008).
B. Glance, J. Lightwave Technol. 5, 274 (1987).
M. V. P. C. Gomez-Reino and C. Bao, Gradient-Index Optics (Springer, 2002).
J. A. Gómez-Pedrero, J. Ginn, J. Alda, and G. Boreman, Appl. Opt. 50, 5344 (2011).
F. Hao, P. Nordlander, Y. Sonnefraud, P. V. Dorpe, and S. A. Maier, “Tunability of subradiant dipolar and Fano-type plasmon resonances in metallic ring/disk cavities: implications for nanoscale optical sensing,” ACS Nano 3, 643-652 (2009).
F. M. Huang, N. Zheludev, Y. Chen, and F. J. G. de Abajo, “Focusing of light by a nanohole array,” Appl. Phys. Lett. 90, 091119 (2007).
P. B. Johnson and R. W. Christy, “Optical constants of the noble metals,” Phys. Rev. B 6, 4370-4379 (1972).
E. H. Khoo, E. P. Li, and K. B. Crozier, “Plasmonic wave plate based on subwavelength nanoslits,” Opt. Lett. 36, 2498-2500 (2011).
Y. S. Kivshar, “Nonlinear optics: the next decade,” Opt. Express 16, 22126-22128 (2008).
H. J. Lezec, A. Degiron, E. Devaux, R. Linke, L. Martin-Moreno, F. Garcia-Vidal, and T. Ebbesen, “Beaming light from a subwavelength aperture,” Science 297, 820-822 (2002).
L. Lin, X. M. Goh, L. P. McGuinness, and A. Roberts, “Plasmonic lenses formed by two-dimensional nanometric cross-shaped aperture arrays for Fresnel-region focusing,” Nano Lett. 10, 1936-1940 (2010).
D. J. Lipomi, M. A. Kats, P. Kim, S. H. Kang, J. Aizenberg, F. Capasso, and G. M. Whitesides, “Fabrication and replication of arrays of single or multicomponent nanostructures by replica molding and mechanical sectioning,” ACS Nano 4, 4017-4026 (2010).
B. Luk'yanchuk, N. I. Zheludev, S. A. Maier, N. J. Halas, P. Nordlander, H. Giessen, and C. T. Chong, “The Fano resonance in plasmonic nanostructures and metamaterials,” Nat. Mater. 9, 707-715 (2010).
Z. L. Mei, J. Bai, and T. J. Cui, “Gradient index metamaterials realized by drilling hole arrays,” J. Phys. D 43, 055404 (2010).
B. Memarzadeh Isfahani, T. Ahamdi Tameh, N. Granpayeh, and A. R. Maleki Javan, “All-optical NOR gate based on nonlinear photonic crystal microring resonators,” J. Opt. Soc. Am. B 26, 1097-1102 (2009).
B. Memarzadeh and H. Mosallaei, “Array of planar plasmonic scatterers functioning as light concentrator,” Opt. Lett. 36, 2569-2571 (2011).
B. Memarzadeh and H. Mosallaei, “Layered plasmonic tripods: an infrared frequency selective surface nanofilter,” J. Opt. Soc. Am. B 29, 2347-2351 (2012).
H. Mosallaei, “FDTD-PLRC technique for modeling of anisotropic-dispersive media and metamaterial devices,” IEEE Trans. Electromagn. Compat. 49, 649-660 (2007).
G. V. Naik, J. Kim, and A. Boltasseva, “Oxides and nitrides as alternative plasmonic materials in the optical range [Invited],” Opt. Mater. Express 1, 1090-1099 (2011).
T. Niu, W. Withayachumnankul, B. S. Y. Ung, H. Menekse, M. Bhaskaran, S. Sriram, and C. Fumeaux, “Experimental demonstration of reflectarray antennas at terahertz frequencies,” Opt. Express 21, 2875-2889 (2013).
E. D. Palik, Handbook of Optical Constants of Solids (Academic, 1985).
N. Papasimakis, Y. H. Fu, V. A. Fedotov, S. L. Prosvirnin, D. P. Tsai, and N. I. Zheludev, “Metamaterial with polarization and direction insensitive resonant transmission response mimicking electromagnetically induced transparency,” Appl. Phys. Lett. 94, 211902-3, (2009).
D. M. Pozar, S. D. Targonski, and R. Pokuls, IEEE Trans. Antennas Propag. 47, 1167 (1999).
E. Prodan, C. Radloff, N. J. Halas, and P. Nordlander, “A hybridization model for the plasmon response of complex nanostructures,” Science 302, 419-422 (2003).
A. Roberts and L. Lin, “Plasmonic quarter-wave plate,” Opt. Lett. 37, 1820-1822 (2012).
J. Sancho-Parramon and S. Bosch, “Dark modes and Fano resonances in plasmonic clusters excited by cylindrical vector beams,” ACS Nano 6, 8415-8423 (2012).
D. J. Shelton, K. R. Coffey, and G. D. Boreman, “Experimental demonstration of tunable phase in a thermochromic infraredreflect array metamaterial,” Opt. Express 18, 1330-1335 (2010).
A. Taflove and S. C. Hagness, Computational Electrodynamics: The Finite-Difference Time-Domain Method (Artech House, 2005).
A. Vakil and N. Engheta, “Fourier optics on graphene,” Phys. Rev. B 85, 075434 (2012).
L. Verslegers, P. B. Catrysse, Z. Yu, J. S. White, E. S. Barnard, M. L. Brongersma, and S. Fan, “Planar lenses based on nanoscale slit arrays in a metallic film,” Nano Lett. 9, 235-238 (2009).
C. Wu, A. B. Khanikaev, R. Adato, N. Arju, A. A. Yanik, H. Altug, and G. Shvets, “Fano-resonant asymmetric metamaterials for ultrasensitive spectroscopy and identification of molecular monolayers,” Nat. Mater. 11, 69-75 (2011).
T. Xu, Y.-K. Wu, X. Luo, and L. J. Guo, “Plasmonic nanoresonators for high-resolution colour filtering and spectral imaging,” Nat. Commun. 1, 59 (2010).
N. Yu, P. Genevet, M. A. Kats, F. Aieta, J.-P. Tetienne, F. Capasso, and Z. Gaburro, “Light propagation with phase discontinuities: generalized laws of reflection and refraction,” Science 334, 333-337 (2011).
Y. Zhao and A. Alù, “Manipulating light polarization with ultrathin plasmonic metasurfaces,” Phys. Rev. B 84, 205428 (2011).
S. Zhang, D. A. Genov, Y. Wang, M. Liu, and X. Zhang, “Plasmoninduced transparency in metamaterials,” Phys. Rev. Lett. 101, 047401 (2008).

What is claimed is:

1. A birefringent infrared reflectarray comprising a planar metasurface disposed on a surface of a substrate, the metasurface comprising a metal layer, a dielectric layer deposited on the metal layer, and a nanoantenna layer deposited on the dielectric layer; wherein the nanoantenna layer comprises a plurality of rectangular metal patches arranged in a two-dimensional rectilinear array, each row of the array comprising a series of said metal patches whose length and/or width increases from one to the next across the row; wherein the patches reflect incident infrared light of wavelength λ and split the incident light into two orthogonal linearly polarized reflections, concentrate the reflected light, and transform the phase front of the incoming polarized light to a desired phase for the two reflections; and wherein the dimensions of the metallic patches are less than λ.

2. The reflectarray according to claim 1, wherein the dielectric layer comprises a material selected from the group consisting of: metal oxides, plastics, mica, ceramic materials, SiO₂, and glass.

3. The reflectarray according to claim 2, wherein the metal layer and the metal patches each comprise gold.

4. The reflectarray according to claim 1, wherein the wavelength of the incident light is in the range of about 3 μm to about 30 μm and the dimensions of the metallic patches are in the range of about 300 nm to about 3 μm.

5. The reflectarray according to claim 1, wherein the thickness of the metal patches is in the range of about 25 nm to about 100 nm.

6. The reflectarray according to claim 1 that is configured as a waveplate.

7. The reflectarray according to claim 1 that is configured as a birefringent modulator.

8. The reflectarray according to claim 1 that is configured as a polarization diversity wavelength multiplexer/de-multiplexer.

9. A birefringent visible light reflectarray comprising a planar metasurface disposed on a surface of a substrate, the metasurface comprising a nanoantenna layer comprising a plurality of ellipsoid particles having a dielectric core and a shell of plasmonic material and arranged into a two-dimensional rectilinear array, each row of the array comprising a series of said particles having a different length along at least one of three axes of the particles from one to the next across the row; wherein the particles reflect incident linearly polarized visible light of wavelength λ and split the incident light into two circularly polarized reflections and transform the phase front of the incident light to a desired phase for the two reflections; and wherein the dimensions of the particles are less than λ.

10. An optical modulator for independently modulating the phase and amplitude of light scattered from the modulator, the modulator comprising a metasurface disposed on a surface of a substrate, the metasurface comprising a first nanoantenna layer disposed on said surface of the substrate and a second nanoantenna layer disposed on the first nanoantenna layer; wherein the first nanoantenna layer comprises a plurality of first nanostructures and the second nanoantenna layer comprises a plurality of second nanostructures, wherein each first nanostructure is disposed directly below a second nanostructure to form a unit cell, wherein the unit cells are arranged in a two-dimensional rectilinear array;
wherein the first nanostructures are L-shaped slot structures in a metal film, the slot structure having arms of lengths h₁ and h₂, wherein h₁ and h₂ are varied from one slot structure to the next across each row of the array while keeping the sum of h₁ and h₂ constant, whereby variation of h₁ and h₂ modulates a transmission amplitude of the scattered light independent of the transmission phase;
wherein the second nanostructures are concentric metal loop structures, whereby variation of the sizes of the loop structures from one to the next across the each row of the array modulates the transmission phase of the scattered light independent of the amplitude.

11. The modulator according to claim 10, wherein the sizes of the loops either increases or decreases going from the center of the loop structure to the periphery of the loop structure.

12. A computing device for performing multiplication comprising the modulator of claim 10, wherein the values of h₁ and h₂ are selected such that the scattered E_{y} amplitude is in the range of about 0.25 to about 10.0 at the resonance frequency of the L-shaped slot.

13. A computing device for performing differentiation comprising the modulator of claim 10, further comprising a Fourier transform (FT) block material disposed on one side of said substrate and an inverse Fourier transform (IFT) block material disposed on the other side of said substrate; wherein each of the FT and the IFT blocks comprises a GRIN flat lens; and wherein an incident beam enters the FT block and is transmitted through the IFT block, whereby the transmitted beam is the first differential with respect to time of the incident beam.

14. A method of performing a computation using light, comprising the steps of:
(a) directing a light beam at the modulator of claim 10, whereby light is scattered from the metasurface; and
(b) measuring a property of the scattered light.

15. The modulator of claim 10, wherein the second nanostructures comprise concentric multimaterial loop structures having a plurality of loops, each loop made from a different plasmonic material, the loops separated by dielectric material, whereby variation of the loop structures across each row of the array changes the transmission phase of the scattered light independent of the amplitude.

16. An optical transmitarray capable of focusing and/or bending transmitted light, the transmitarray comprising a planar metasurface disposed on a surface of a substrate, the metasurface comprising a nanoantenna layer deposited on a dielectric layer; wherein the nanoantenna layer comprises a plurality of metal nanostructures arranged in a two-dimensional rectilinear array, each row of the array comprising a series of said nanostructures whose shape and/or dimension change from one to the next across the row; wherein the nanostructures transmit incident light of wavelength λ and modulate its phase; and wherein dimensions of the nanostructures are less than λ.

17. The transmitarray according to claim 16, wherein the nanostructures are flat metal structures having a geometry selected from the group consisting of rectangular loops, concentric rectangular loops, squares, and rectangles.

18. The transmitarray according to claim 17, wherein the nanostructures vary along each row in the number of concentric loops, gap size between concentric loops, loop size, loop thickness, loop material, and/or use of closed vs. open nanostructures.

19. The transmitarray according to claim 16, wherein the nanostructures are core-shell nanoparticles that vary in diameter, aspect ratio, core diameter, shell thickness, core material, and/or shell material.

20. The transmitarray according to claim 16, comprising a second dielectric layer disposed on the nanoantenna layer and a second nanoantenna layer disposed on the second dielectric layer.

21. The transmitarray according to claim 19, comprising a third dielectric layer disposed on the second nanoantenna layer and a third nanoantenna layer disposed on the third dielectric layer.

22. The transmitarray according to claim 16, wherein the nanostructures are asymmetric with respect to their x and y axes, and wherein the transmitarray is capable of converting a linearly polarized incident light beam into a circularly polarized transmitted light beam.

23. A device for altering the amplitude, phase, polarization, and/or direction of incident light, the device comprising a metasurface deposited on a surface of a substrate, the metasurface comprising one or more nanoantenna layers, each nanoantenna layer comprising a two-dimensional rectilinear array of nanostructures comprising a plasmonic material and having dimensions less than the wavelength of the incident light, and the nanoantenna layers separated by dielectric layers; wherein the nanostructure geometry, size, aspect ratio, and/or composition are varied across each row of the array according to a graded pattern.

24. The device according to claim 23, further comprising a reflective metal layer between a nanoarray layer and the substrate, wherein the device is configured as a reflectarray.

25. The device according to claim 23 that is devoid of reflective or opaque material beneath the nanoantenna layer or layers, wherein the device is configured as a transmitarray.
